(19) United States
(12) Patent Application Publication
(10) Pub. No.: US 2013/0333024 A1
(43) Pub. Date: Dec. 12, 2013

(54) RANDOM VALUE IDENTIFICATION DEVICE, RANDOM VALUE IDENTIFICATION SYSTEM, AND RANDOM VALUE IDENTIFICATION METHOD

(71) Applicant: Takao Takenouchi, Tokyo (JP)

(72) Inventor: Takao Takenouchi, Tokyo (JP)

(73) Assignee: NEC CORPORATION, Tokyo (JP)

(21) Appl. No.: 14/001,447

(22) PCT Filed: Feb. 17, 2012
(86) PCT No.: PCT/JP12/54483

§ 371 Date: Aug. 23, 2013

(30) Foreign Application Priority Data
Mar. 4, 2011 (JP) 2011-047929

(51) Int. Cl. G06F 21/31

(52) U.S. Cl. CPC G06F 21/31
USPC 726/19

(57) ABSTRACT

It is not possible to identify a suitable random value that can increase the validity of data after adding a random data and causing the concealment of original data values.

In the present invention, authorization information indicating at last one attribute that a user authorizes to be disclosed is associated with a user identifier and recorded; an attribute name indicating a first attribute is received; a second attribute is identified corresponding to a cumulative number wherein each attribute is indicated among the attributes that the authorization information indicating the first attribute indicates; an attribute value corresponding to the first attribute and second attribute of the user identified by the user identifier associated with the authorization information is acquired for each authorization information indicating the second attribute; the correlation between the first attribute and the second attribute is identified on the basis of the acquired attribute value; and a random number is generated for each attribute within a random value range that is a range in which the random number can take between the first attribute and the second attribute and that is identified on the basis of the identified correlation.

### FIELD OF THE INVENTION

The present invention relates to a technology which identifies a random value for concealing a value of original data.

### BACKGROUND OF THE INVENTION

A technology for concealing a value of original data by adding a random value (random number value) to the value of the original data is known.

For example, the technology disclosed in patent document 1 converts the original data in disturbance data by using a process including a random step. Then, the technology performs a statistical process in which the effect of the random step is eliminated based on the disturbance data.

And, a technology described in non-patent document 1 generates the disturbance data by adding a random noise (random number) to the original data based on a correlation of an attribute value between predetermined attributes. Then, the technology performs a statistical process based on the disturbance data.
[Patent document 1] Japanese Patent Application Laid-Open No. 2007-288480
[Non-patent document 1] Zhengli Huang et al., “Deriving Private Information from Randomized Data” In Proc. of the ACM SIGMOD, pages 37-48, 2005.

### SUMMARY OF THE INVENTION

### Problems to be Solved by the Invention

The technologies described in patent document 1 and non-patent document 1 remove the influence of the random data by performing the statistical process using a plurality of disturbance data. Therefore, in the technologies described in patent document 1 and non-patent document 1, the value of each disturbance data is greatly different from the value of the original data, and data which has a value that is essentially not taken by the original data is included in the disturbance data. As for such each disturbance data, the validity of data is spoiled. Accordingly, the technologies described in patent document 1 and non-patent document 1 cannot identify an appropriate random value that can conceal the value of the original data and increase the validity of data after adding the random value.

One of the objects of the present invention is to provide a random value identification device, a random value identification system, and a random value identification method which identify an appropriate random value that can conceal a value of original data and increase a validity of data after adding a random value.

### Means for Solving the Problem

A first random value identification device according to one aspect of the present invention includes: permission information storage means for storing permission information indicating at least one attribute of which a user permits disclosure and a user identifier of the user so that they are associated; reception means for receiving an attribute name indicating a first attribute of information related to the user; attribute correlation identification means for reading at least one permission information indicating the first attribute indicated by the attribute name from the permission information storage means, identifying a second attribute according to a cumulative total number indicated for each attribute among the attributes indicated by the read permission information, and identifying the permission information indicating the second attribute in the read permission information; attribute value acquisition means for acquiring an attribute value corresponding to the first attribute and the second attribute of the user identified by the user identifier associated with the permission information for each the identified permission information; correlation identification means for identifying a correlation between the first attribute and the second attribute based on the acquired attribute value; and random number generation means for generating a random number for each attribute in a random value range which is a range in which the random number can be taken between the first attribute and the second attribute which are identified based on the correlation.

A first random value identification system according to one aspect of the present invention includes: a search provider device; and a random value identification device; wherein the search provider device includes: query transmission means for transmitting an attribute name indicating a first attribute of information related to a user to the random value identification device; and the random value identification device includes: attribute value storage means for storing a user identifier, the attribute name, and an attribute value so that they are associated; permission information storage means for storing permission information indicating at least one attribute of which the user permits disclosure and the user identifier of the user so that they are associated; reception means for receiving the attribute name from the search provider device; attribute correlation identification means for reading at least one permission information indicating a first attribute indicated by the attribute name from the permission information storage means, identifying a second attribute according to a cumulative total number indicated for each attribute among the attributes indicated by the read permission information, and identifying the permission information indicating the second attribute in the read permission information; attribute value acquisition means for acquiring the attribute value which is stored and associated with the first attribute and the second attribute of the user identified by the user identifier associated with the permission information for each the identified permission information from the attribute value storage means; correlation identification means for identifying a correlation between the first attribute and the second attribute based on the acquired attribute value; random number generation means for generating a random number for each attribute in a random value range which is a range in which the random number can be taken between the first attribute and the second attribute which are identified based on the correlation; random number addition means for adding the generated random value to the attribute value of the corresponding attribute; and transmission means for transmitting information to which the random value is added to the search provider device.

A second random value identification system according to one aspect of the present invention includes: a search provider device; an information storing provider device; and a random value identification device; wherein the search provider device includes: query transmission means for transmitting a user identifier and an attribute name indicating a first attribute of information related to the user to the information storing provider device; the information storing provider device includes: attribute value storage means for storing the user identifier, the attribute name, and an attribute value so that they are associated; reception means for receiving the user identifier and the attribute name from the search provider device, and transmitting the attribute name to the random value identification device; attribute value acquisition means for acquiring the attribute value associated with the attribute name and the user identifier which are received from the random value identification device from the attribute value storage means; transmission means for transmitting the attribute value to the random value identification device; and random number addition means for receiving a random value for each attribute from the random value identification device, and adding the random value of the attribute corresponding to the attribute value to the attribute value acquired by the attribute value acquisition means; and the random value identification device includes: permission information storage means for storing permission information indicating at least one attribute of which the user permits disclosure and the user identifier of the user so that they are associates; reception means for receiving the attribute name from the information storing provider device; attribute correlation identification means for reading at least one permission information indicating the first attribute indicated by the attribute name from the permission information storage means, identifying a second attribute according to a cumulative total number indicated for each attribute among the attributes indicated by the read permission information, and identifying the permission information indicating the second attribute in the read permission information; attribute value request means for transmitting the user identifier associated with the permission information for each the identified permission information and the attribute name indicating the first attribute and the second attribute of the user identified by the user identifier to the information storing provider device; correlation identification means for identifying a correlation between the first attribute and the second attribute based on the attribute value received from the information storing provider device; random number generation means for generating a random number for each attribute in a random value range which is a range in which the random number can be taken between the first attribute and the second attribute which are identified based on the identified correlation; and random number transmission means for transmitting the generated random value to the information storing provider device.

A first random value identification method according to one aspect of the present invention includes: storing permission information indicating at least one attribute of which a user permits disclosure and a user identifier of the user so that they are associated in permission information storage means; receiving an attribute name indicating a first attribute of information related to the user; reading at least one permission information indicating the first attribute indicated by the attribute name from the permission information storage means, identifying a second attribute according to a cumulative total number indicated for each attribute among the attributes indicated by the read permission information, and identifying the permission information indicating the second attribute in the read permission information; acquiring an attribute value corresponding to the first attribute and the second attribute of the user identified by the user identifier associated with the permission information for each the identified permission information, identifying a correlation between the first attribute and the second attribute based on the acquired attribute value; and generating a random number for each attribute in a random value range which is a range in which the random number can be taken between the first attribute and the second attribute which are identified based on the correlation.

A second random value identification method according to one aspect of the present invention includes: a search provider device transmits a user identifier and an attribute name indicating a first attribute of information related to the user to a random value identification device; and the random value identification device stores the user identifier, the attribute name, and an attribute value so that they are associated, stores permission information indicating at least one attribute of which the user permits disclosure and the user identifier which can identify the user in permission information storage means so that they are associated, receives the user identifier and the attribute name from the search provider device, reads at least one permission information indicating the first attribute indicated by the attribute name from the permission information storage means, identifies a second attribute according to a cumulative total number indicated for each attribute among the attributes indicated by the read permission information, identifies the permission information indicating the second attribute in the read permission information, acquires the attribute value which is stored and associated with the first attribute and the second attribute of the user identified by the user identifier associated with the permission information for each the identified permission information from the attribute value storage means, identifies a correlation between the first attribute and the second attribute based on the acquired attribute value, generates a random number for each attribute in a random value range which is a range in which the random number can be taken between the first attribute and the second attribute which are identified based on the correlation, adds the generated random value to the attribute value of the corresponding attribute, and transmits the information to which the random value is added to the search provider device.

A third random value identification method according to one aspect of the present invention includes: a search provider device transmits a user identifier and an attribute name indicating a first attribute of information related to the user to an information storing provider device; the information storing provider device stores the user identifier, the attribute name, and an attribute value so that they are associated, receives the user identifier and the attribute name from the search provider device, transmits the attribute name to the random value identification device, acquires the attribute value associated with the attribute name and the user identifier which are received from the random value identification device from the attribute value storage means, transmits the attribute value to the random value identification device, receives a random value from the random value identification device for each attribute, and adds the random value of the attribute corresponding to the attribute value to the acquired attribute value; and the random value identification device stores permission information indicating at least one attribute of which the user permits disclosure and the user identifier of the user in permission information storage means so that they are associated, receives the attribute name from the information storing provider device, reads at least one permission information indicating the first attribute indicated by the attribute name from the permission information storage means, identifies a second attribute according to a cumulative total number indicated for each attribute among the attributes indicated by the read permission information, identifies the permission information indicating the second attribute in the read permission information, transmits the user identifier associated with permission information for each the identified permission information and the attribute name indicating the first attribute and the second attribute of the user identified by the user identifier to the information storing provider device, identifies a correlation between the first attribute and the second attribute based on the attribute value received from the information storing provider device, generates a random number for each attribute in a random value range which is a range in which the random number can be taken between the first attribute and the second attribute which are identified based on the identified correlation, and transmits the generated random value to the information storing provider device.

A first random value identification program according to one aspect of the present invention causing a computer to execute: a process of storing permission information indicating at least one attribute of which a user permits disclosure and a user identifier of the user in permission information storage means so that they are associated; a process of receiving an attribute name indicating a first attribute of information related to the user; a process of reading at least one permission information indicating the first attribute indicated by the attribute name from the permission information storage means, identifying a second attribute according to a cumulative total number indicated for each attribute among the attributes indicated by the read permission information, and identifying the permission information indicating the second attribute in the read permission information, a process of acquiring an attribute value corresponding to the first attribute and the second attribute of the user identified by the user identifier associated with the permission information for each the identified permission information; a process of identifying a correlation between the first attribute and the second attribute based on the acquired attribute value; and a process of generating a random number for each attribute in a random value range which is a range in which the random number can be taken between the first attribute and the second attribute which are identified based on the correlation.

### Effect of the Invention

An example of the effect of the present invention is to be able to identify an appropriate random value by which a value of original data can be concealed and a validity of data after adding the random value can be increased.

### BRIEF DESCRIPTION OF THE DRAWINGS

FIG. 1 is a block diagram showing a configuration of a random value identification device according to a first exemplary embodiment.

FIG. 2 is a figure showing an example of information stored by the permission information storage unit.

FIG. 3 is a figure showing a hardware configuration of a random value identification device according to the first exemplary embodiment and peripheral devices.

FIG. 4 is a flowchart showing an outline of operation of the random value identification device according to the first exemplary embodiment.

FIG. 5 is a block diagram showing a configuration of a random value identification system according to a second exemplary embodiment.

FIG. 6 is a figure showing an example of information stored by an attribute value storage unit.

FIG. 7 is a figure showing an example of information stored by a random value storage unit.

FIG. 8 is a figure showing an example of a predetermined subspace identified by a random value range identification unit.

FIG. 9 is a figure showing an example of a predetermined subspace identified by a random value range identification unit.

FIG. 10 is a figure showing an example of a predetermined subspace identified by a random value range identification unit.

FIG. 11 is a figure showing an example in which the subspace shown in FIG. 2 is rotated.

FIG. 12 is a figure showing a certain attribute value, a range in which a value after adding a random number to the attribute value can be taken, and a function indicating a correlation between an attribute “age” and “annual income”.

FIG. 13 is a flowchart showing an outline of operation of the random value identification system according to the second exemplary embodiment.

FIG. 14 is a flowchart showing an outline of operation of the random value range identification unit according to the second exemplary embodiment.

FIG. 15 is a block diagram showing a configuration of a random value identification system according to a first modification example of the second exemplary embodiment.

FIG. 16 is a block diagram showing a configuration of a random value identification system according to a second modification example of the second exemplary embodiment.

FIG. 17 is a block diagram showing a configuration of a random value identification system according to a third exemplary embodiment.

FIG. 18 is a block diagram showing a configuration of an information storing provider device according to the third exemplary embodiment.

FIG. 19 is a block diagram showing a configuration of a random value identification system according to the third exemplary embodiment.

FIG. 20 is a flowchart showing an outline of operation of a random value identification system according to the third exemplary embodiment.

### EXEMPLARY EMBODIMENT OF THE INVENTION

An exemplary embodiment for carrying out the present invention will be described in detail with reference to the drawing. Further, in each drawing and each exemplary embodiment described in the specification, the same reference number is used for the element having a similar function. And, the detailed explanation of the element to which the same reference number is assigned may be omitted.

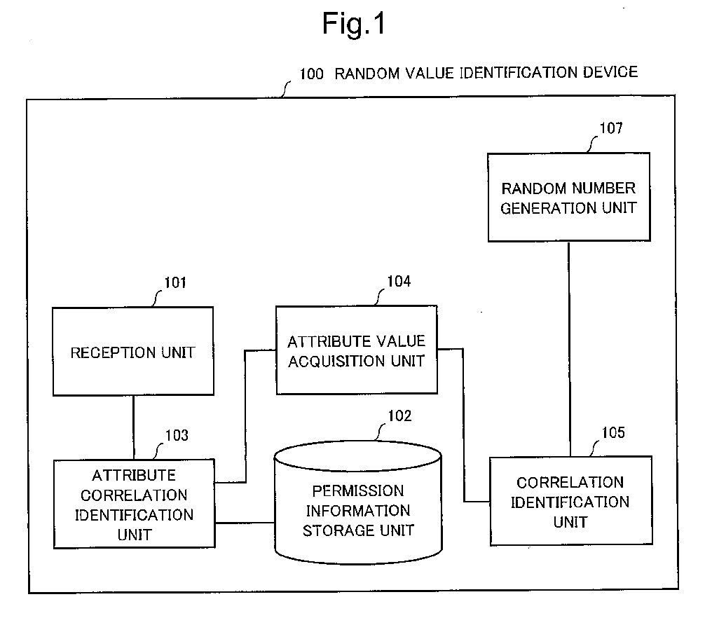

FIG. 1 is a block diagram showing a configuration of a random value identification device 100 according to a first exemplary embodiment of the present invention. Referring to FIG. 1, the random value identification device 100 includes a reception unit 101, a permission information storage unit 102, an attribute correlation identification unit 103, an attribute value acquisition unit 104, a correlation identification unit 105, and a random number generation unit 107.

The random value identification device 100 according to the first exemplary embodiment identifies a second attribute according to a cumulative total number indicated for each attribute among the attributes indicated by at least one permission information which indicates a first attribute indicated by the received attribute name. Next, the random value identification device 100 acquires the attribute value corresponding to the first attribute and the second attribute, and identifies a correlation between the first attribute and the second attribute based on the acquired attribute value. Then, the random value identification device 100 identifies a random value range which is a range in which a random number can be taken between the first attribute and the second attribute based on the identified correlation.

The random value range is based on the correlation between the first attribute specified by an external device or the like used by a user and the second attribute identified by the random value identification device 100 based on the first attribute. Therefore, the random value identification device 100 does not consider the correlation of all the attributes, but identifies the random value range based on the correlation between the second attribute identified so that the user permits disclosure like the first attribute and the first attribute.

There is a high possibility that the information on the attribute of which a certain user permits disclosure has a high possibility of being combined and used for data mining or the like in the future. Therefore, even when the random number included in the above-mentioned random value range is added to the attribute value, the value is converted into a value in a range in which it is expected that another user performs data mining. Therefore, the validity of the data after adding the random value can be maintained and confidentiality of the original data is maintained.

Accordingly, the random value identification device 100 according to the first exemplary embodiment can identify an appropriate random value which can conceal the value of the original data and increase the validity of the data after adding the random value.

Hereinafter, each element included in the random value identification device 100 will be described.

===Reception Unit 101===

The reception unit 101 receives an attribute name indicating the attribute of information related to the user from other function means or an external device which is not shown in the figure. In this specification, the attribute indicated by the attribute name received by the reception unit 101 is represented as a first attribute.

For example, the information related to the user includes all information such as personal information such as a user's age or annual income, a rent or an years of construction of a user's house, a distance from a station to the user's house, academic ability of a user's child, information about a user's preference (information about smoking, drinking, and exercise experience), and the like.

The attribute of the information related to the user is information indicating a certain specific item related to the user and a value of the item. The attribute name of the information related to the user is information indicating a certain specific item related to the user. The attribute value of the attribute of the information related to the user is a value to a certain specific item related to the user.

In other words, the attribute of the information related to the user is, for example, information of “age=10 years old” in the information of “Alice is 10 years old”. Then, in the above-mentioned example, the attribute name of the information related to the user is “age”. Similarly, the attribute value of the attribute of the information related to the user is “10 years old”. And, in the above-mentioned example, “Alice” is the user identifier.

The reception unit 101 may receive the attribute name and the user identifier which can identify the user. The user identifier is a symbol which can identify a user name or a user.

The number of the first attributes indicated by the attribute name is not only single but also plural.

===Permission Information Storage Unit 102===

The permission information storage unit 102 stores the permission information indicating at least one attribute of which the user permits disclosure and the user identifier which can identify the user so that they are associated.

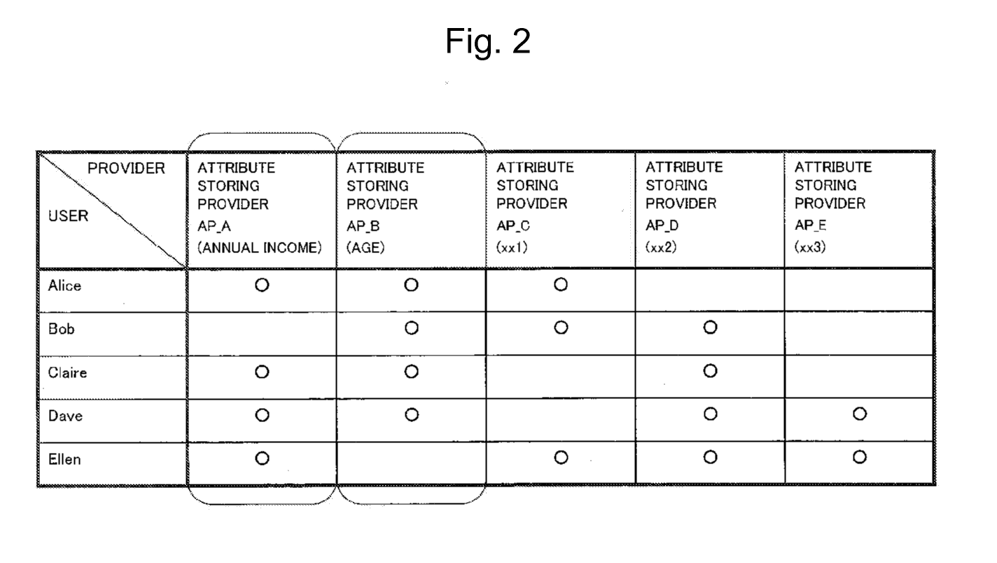

FIG. 2 is a figure showing an example of information stored by the permission information storage unit 102. Referring to FIG. 2, the permission information storage unit 102 stores the user identifier “Alice” and the permission information so that they are associated. The permission information of the user “Alice” indicates the permission of the disclosure of the attribute name “annual income”, “age”, and “xx1”. Similarly, the permission information storage unit 102 stores the user identifier “Bob”, “Claire”, “Dave”, and “Ellen” and the permission information of each user so that they are associated. In an example shown in FIG. 2, a condition in which an information storing provider AP_A stores information related to the attribute name “annual income” is assumed. Similar conditions are assumed to other information storing providers.

The permission information storage unit 102 may store provider permission information indicating the provider of which the user permits disclosure so that it is associated with the user identifier and the permission information. An example of information processing using the provider permission information will be described later.

The random value identification device 100 may include the permission information storage unit 102 for each provider. In this case, each provider transmits a provider identifier indicating the provider together with the attribute name to the random value identification device 100 via an external device which is not shown in the figure. Then, the random value identification device 100 performs based on the information stored in the permission information storage unit 102 corresponding to the received provider identifier.

===Attribute Correlation Identification Unit 103===

First, the attribute correlation identification unit 103 reads at least one permission information indicating the attribute (first attribute) indicated by the attribute name received by the reception unit 101 from the permission information storage unit 102.

For example, it is assumed that the reception unit 101 receives the attribute name “annual income” of the first attribute, and it is assumed that the permission information storage unit 102 stores information shown in FIG. 2. In this case, the attribute correlation identification unit 103 reads at least one permission information among the permission information of “Alice”, “Claire”, “Dave”, and “Ellen” from the permission information storage unit 102. The attribute correlation identification unit 103 may read all the permission information of “Alice”, “Claire”, “Dave”, and “Ellen” from the permission information storage unit 102.

Secondly, the attribute correlation identification unit 103 identifies a certain attribute as a second attribute according to the cumulative total number indicated for each attribute among the attributes indicated by the permission information read from the permission information storage unit 102.

For example, in the above-mentioned example, the case in which the attribute correlation identification unit 103 reads all the permission information of “Alice”, “Claire”, “Dave”, and “Ellen” from the permission information storage unit 102 is assumed. At this time, the attribute correlation identification unit 103 calculates the cumulative total of the attribute indicated by each permission information for each attribute. For example, referring to FIG. 2, because the cumulative total of the attribute name “age” is included in the permission information of “Alice”, “Claire”, and “Dave”, it is calculated as “3”. Similarly, the cumulative total of the attribute name “xx1” is calculated as “2”, the cumulative total of the attribute name “xx2” is calculated as “3”, and the cumulative total of the attribute name “xx3” is calculated as “2”.

The number of the second attributes is not only single but also plural. And, the second attribute may be the attribute different from the first attribute.

For example, the attribute correlation identification unit 103 may identify the attribute whose calculated cumulative total is the maximum as the second attribute. In this case, the attribute correlation identification unit 103 identifies the attribute “age” and “xx2” as the second attribute. Or, for example, the attribute correlation identification unit 103 may identify the attribute whose calculated cumulative total number is equal to or greater than a predetermined number as the second attribute. Or, for example, the attribute correlation identification unit 103 may identify the attributes of a predetermined number sequentially from the way with much calculated cumulative total number as the second attribute.

Thirdly, the attribute correlation identification unit 103 identifies the permission information indicating the above-mentioned second attribute in the permission information read from the permission information storage unit 102.

For example, in the above-mentioned example, when the attribute correlation identification unit 103 identifies the second attribute as “age”, the attribute correlation identification unit 103 identifies the permission information of “Alice”, “Claire”, and “Dave”.

When the reception unit 101 receives the user identifier, the attribute correlation identification unit 103 may identify the above-mentioned second attribute among the attributes indicated by the permission information associated with the user identifier. For example, the case in which the reception unit 101 receives the user identifier “Alice” and the attribute name “annual income” is assumed. The attribute correlation identification unit 103 reads the permission information of “Alice”, “Claire”, “Dave”, and “Ellen” from the permission information storage unit 102. Then, the attribute correlation identification unit 103 calculates the cumulative total of the attribute indicated by each permission information for each attribute. For example, the attribute correlation identification unit 103 identifies the attribute whose calculated cumulative total is the maximum as the second attribute. Then, the attribute correlation identification unit 103 identifies the second attribute among the attribute “annual income”, “age”, and “xx1” indicated by the permission information associated with the user identifier “Alice” received by the reception unit 101. At this time, the attribute correlation identification unit 103 identifies the attribute “age” whose calculated cumulative total is the maximum and which is indicated by the permission information associated with the user identifier “Alice” received by the reception unit 101 as the second attribute.

When the reception unit 101 receives the user identifier, the attribute correlation identification unit 103 may perform the following process. Namely, the attribute correlation identification unit 103 may identify the permission information which indicates a predetermined number or over of the attributes among the attributes indicated by the permission information associated with the user identifier in the permission information read from the permission information storage unit 102. Then, the attribute correlation identification unit 103 may identify the second attribute according to the cumulative total number indicated for each attribute among the attributes indicated by the identified permission information.

For example, the case in which the reception unit 101 receives the user identifier “Alice” and the attribute “annual income” is assumed. The attribute correlation identification unit 103 reads the permission information of “Alice”, “Claire”, “Dave”, and “Ellen” from the permission information storage unit 102. Then, the attribute correlation identification unit 103 identifies the permission information which indicates a predetermined number or over of, for example two or over, the attributes which are the same as the attributes indicated by the permission information of “Alice” in the permission information read from the permission information storage unit 102.

Here, the permission information of “Alice” indicates the attribute “annual income”, “age”, and “xx1”. The permission information of “Claire” indicates the attribute “annual income”, “age”, and “xx2”. The attribute “annual income” and “age” are common between the permission information of “Alice” and the permission information of “Claire” as identified attributes. The permission information of “Dave” indicates the attribute “annual income”, the attribute “age”, “xx2”, and “xx3”. The attribute “annual income” and “age” are common between the permission information of “Alice” and the permission information of “Dave” as identified attributes. The permission information of “Ellen” are the attribute “annual income”, “xx1”, “xx2”, and “xx3”. The attribute “annual income” and “xx1” are common between the permission information of “Alice” and the permission information of “Ellen” as identified attributes. In other words, the attribute correlation identification unit 103 judges that all the permission information of “Alice”, “Claire”, “Dave”, and “Ellen” indicates two or over the same attributes. Therefore, the attribute correlation identification unit 103 identifies the permission information of “Alice”, “Claire”, “Dave”, and “Ellen”.

When the reception unit 101 receives the user identifier, the attribute correlation identification unit 103 may perform the following process. Namely, the attribute correlation identification unit 103 may calculate a common degree between the attribute indicated by the permission information associated with the user identifier and the attribute indicated by the permission information read from the permission information storage unit 102. Then, the attribute correlation identification unit 103 may identify the permission information whose calculated common degree is equal to or greater than a predetermined value in the permission information read from the permission information storage unit 102. Then, the attribute correlation identification unit 103 may identify the second attribute according to the cumulative total number indicated for each attribute among the attributes indicated by the identified permission information.

For example, a case in which the reception unit 101 receives the user identifier “Alice” and the attribute name “annual income” is assumed. The attribute correlation identification unit 103 reads the permission information of “Alice”, “Claire”, “Dave”, and “Ellen” from the permission information storage unit 102. Then, the attribute correlation identification unit 103 calculates the common degree between the attribute indicated by the permission information of “Alice” and the attribute indicated by the permission information read from the permission information storage unit 102.

Here, the permission information of “Alice” indicates the attribute “annual income”, “age”, and “xx1”. The permission information of “Claire” indicates the attribute “annual income”, “age”, and “xx2”. The attribute names of which indicated attributes are common between the permission information of “Alice” and the permission information of “Claire” are two which are “annual income” and “age”. And, the attribute name of which not indicated attribute is common between the permission information of “Alice” and the permission information of “Claire” is only one which is “xx3”. Therefore, the attribute correlation identification unit 103 calculates a score of the common degree between the permission information of “Alice” and the permission information of “Claire” as 1+2=“3”.

Similarly, the attribute correlation identification unit 103 calculates the score of the common degree between the permission information of “Alice” and the permission information of “Dave” as 2+0=“2”, and calculates the score of the common degree between the permission information of “Alice” and the permission information of “Ellen” as 2+0=“2”.

The attribute correlation identification unit 103 identifies the permission information whose calculated score of the common degree is equal to or greater than the predetermined value, for example 3 or more, in the permission information read from the permission information storage unit 102. In this case, the attribute correlation identification unit 103 identifies the permission information of “Claire”.

When the permission information storage unit 102 stores the provider permission information, each provider sends the provider identifier indicating the provider to the random value identification device 100 via an external device which is not shown in the figure. Then, when the provider indicated by the received provider identifier is included in the provider indicated by the provider permission information associated with the permission information read from the permission information storage unit 102, the attribute correlation identification unit 103 may perform the following process. Namely, the attribute correlation identification unit 103 may send the user identifier and the attribute information to the attribute value acquisition unit 104. On the other hand, when the provider indicated by the received provider identifier is not included in the provider indicated by the provider permission information associated with the permission information read from the permission information storage unit 102, the attribute correlation identification unit 103 performs the following process. Namely, the attribute correlation identification unit 103 transmits the information indicating that the search fails to the above-mentioned external device.

===Attribute Value Acquisition Unit 104===

The attribute value acquisition unit 104 acquires the attribute value corresponding to the first attribute and the second attribute of the user who can be identified by the user identifier associated with the permission information for each permission information identified by the attribute correlation identification unit 103.

The attribute value acquisition unit 104 may acquire the attribute value corresponding to the attribute name indicating the first attribute and the second attribute which are associated with the user identifier received by the reception unit 101 from the attribute value storage unit which is not shown in the figure. For example, this attribute value storage unit stores the user identifier, the attribute name, and the attribute value so that they are associated. And, the attribute value storage unit may be included in the random value identification device 100 or may be included in an external device which is not shown in the figure.

===Correlation Identification Unit 105===

The correlation identification unit 105 identifies the correlation between the first attribute and the second attribute based on the attribute value acquired by the attribute value acquisition unit 104.

The correlation is, for example, a function between the attribute values corresponding to the attributes of the attribute values. However, this correlation is not necessarily a one to one function, but, for example, may be a multiple-value function.

The correlation identification unit 105 may calculate a regression curve or a regression line as the correlation between the first attribute and the second attribute based on the attribute value acquired by the attribute value acquisition unit 104. Then, the correlation identification unit 105 may identify information indicating the regression curve or the regression line as the correlation information indicating the correlation.

When the correlation identification unit 105 calculates the regression curve or the regression line between the attributes, it may calculate by using the attribute of which the attribute value indicates a predetermined value.

The correlation identification unit 105 calculates a correlation coefficient based on the calculated regression curve or the regression curve, and sends it to the random number generation unit 107 described later.

===Random Number Generation Unit 107===

The random number generation unit 107 generates a random number for each attribute in the random value range which is identified based on the correlation identified by the correlation identification unit 105. The random value range is a range in which the random number can be taken between the attributes identified by the correlation identification unit 105. The random value range is identified by a random value range identification unit which is not shown in the figure. The random value identification device 100 may include this random value range identification unit, or other external device which is not shown in the figure may include it.

The random number generation unit 107 may stores the attribute name and the random value added to the attribute value of the attribute indicated by the attribute name so that they are associated in a random value storage unit which is not shown in the figure. In this case, when the received attribute name is stored in the above-mentioned random value storage unit, the reception unit 101 may identify the random value which is stored in the random value storage unit so that it is associated with the attribute name as the random value added to the attribute value of the attribute indicated by the attribute name. And, in this case, a part or all of the process performed by the attribute correlation identification unit 103, the attribute value acquisition unit 104, the correlation identification unit 105, and the random number generation unit 107 may be omitted.

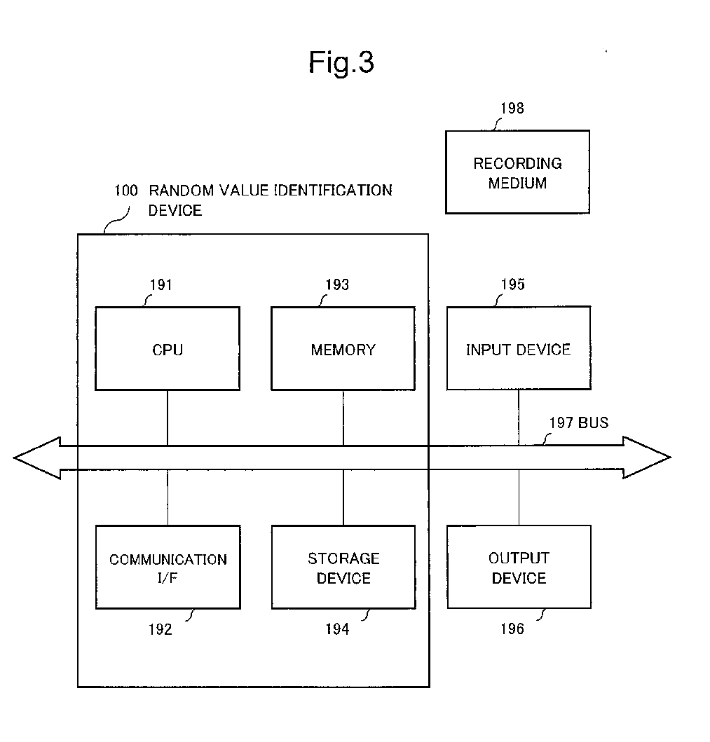

FIG. 3 is a figure showing a hardware configuration of the random value identification device 100 according to the first exemplary embodiment of the present invention and peripheral devices. As shown in FIG. 3, the random value identification device 100 includes a CPU 191, a communication I/F (Interface) 192 for network connection (communication interface 192), a memory 193, and a storage device 194 such as a hard disk or the like which stores a program. And, the random value identification device 100 connects to an input device 195 and an output device 196 via a bus 197.

The CPU 191 controls the entire random value identification device 100 according to the first exemplary embodiment of the present invention by operating an operating system. And, the CPU 191, for example, reads a program and data from a recording medium 198 mounted on the drive device or the like to the memory 193. Then, the CPU 191 performs various processes as the reception unit 101, the attribute correlation identification unit 103, the attribute value acquisition unit 104, the correlation identification unit 105, and the random number generation unit 107 of the first exemplary embodiment according to the read program and data.

The storage device 194 is, for example, an optical disk, a flexible disk, a magnetic optical disk, an external hard disk, a semiconductor memory, or the like, and stores a computer program as computer readable.

And, the computer program may be downloaded from an external computer which is not shown in the figure connected to a communication network. The permission information storage unit 102 according to the first exemplary embodiment is included in the storage device 194.

The input device 195 is, for example, realized by a mouse, a keyboard, a built-in key/button, and the like, and used for input operation. The input device 195 may be not only the mouse, the keyboard, and the built-in key/button but also, for example, a touch panel, an accelerometer, a gyro sensor, a camera or the like.

The output device 196 is, for example, realized by a display, and used for checking the output.

Further, the block diagram (FIG. 1) used for explaining the first exemplary embodiment dose not show a hardware unit configuration but shows a functional block diagram. These functional blocks are realized based on a hardware configuration shown in FIG. 3. However, realizing means of each unit which the random value identification device 100 includes are not limited in particular. Namely, the random value identification device 100 may be realized by using one device which is physically combined or may be realized by using two or more devices which are physically separated from each other and connected by a wired line or a wireless line.

And, the CPU 191 may read the computer program stored in the storage device 194, and operate as the reception unit 101, the attribute correlation identification unit 103, the attribute value acquisition unit 104, the correlation identification unit 105, and the random number generation unit 107 according to the program.

And, the recording medium (or the storage medium) which stores a code of the above-mentioned program is supplied to the random value identification device 100, and the random value identification device 100 may read the code of the program stored in the recording medium and execute the program. Namely, the present invention also includes the recording medium 198 which temporarily stores or non-temporarily stores software (information processing program) for executed by the random value identification device 100 according to the first exemplary embodiment.

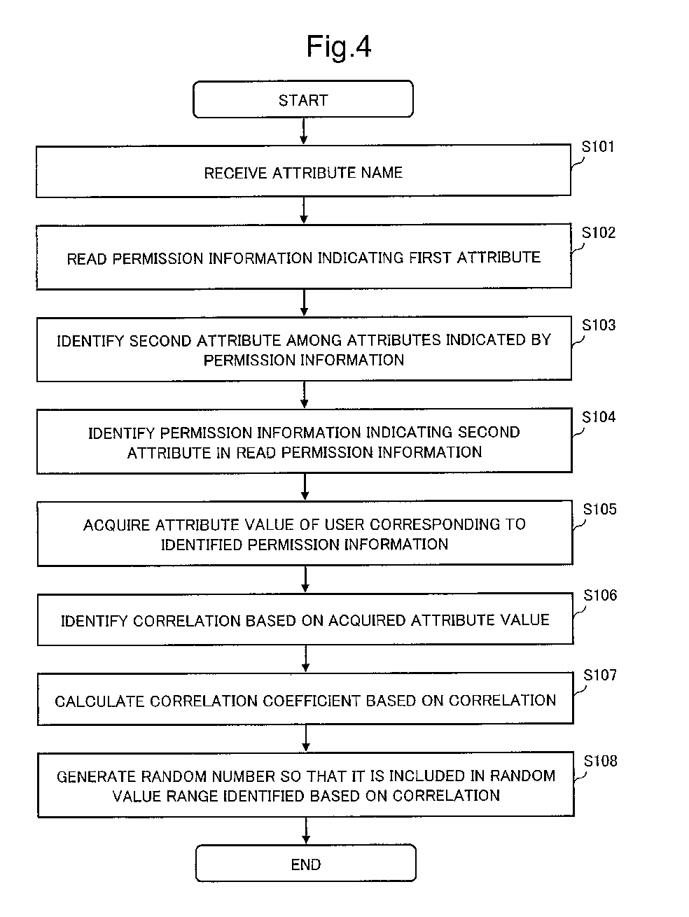

FIG. 4 is a flowchart showing an outline of operation of the random value identification device 100 according to the first exemplary embodiment.

The reception unit 101 receives the attribute name indicating the attribute of the information related to the user (step S101).

The attribute correlation identification unit 103 reads at least one permission information indicating the attribute (first attribute) indicated by the attribute name received by the reception unit 101 from the permission information storage unit 102 (step S102). The attribute correlation identification unit 103 identifies a certain attribute as the second attribute according to the cumulative total number indicated the attribute based on the read permission information among the attributes indicated by the permission information read from the permission information storage unit 102 (step S103). The attribute correlation identification unit 103 identifies the permission information indicating the above-mentioned second attribute in the permission information read from the permission information storage unit 102 (step S104).

The attribute value acquisition unit 104 acquires the attribute value corresponding to the first attribute and the second attribute of the user who can be identified by the user identifier associated with the permission information for each permission information identified by the attribute correlation identification unit 103 (step S105).

The correlation identification unit 105 identifies the correlation between the first attribute and the second attribute based on the attribute value acquired by the attribute value acquisition unit 104 (step S106). The correlation identification unit 105 calculates the correlation coefficient based on the identified correlation, and sends it to the random number generation unit 107 (step S107).

The random number generation unit 107 generates a random number for each attribute in the random value range which is a range in which the random number can be taken between the first attribute and the second attribute corresponding to the correlation identified based on the correlation identified by the correlation identification unit 105 (step S108).

The random value identification device 100 according to the first exemplary embodiment identifies the second attribute according to the cumulative total number indicated for each attribute among the attributes indicated by at least one permission information indicating the first attribute indicated by the received attribute name. Next, the random value identification device 100 acquires the attribute value corresponding to the first attribute and the second attribute, and identifies the correlation between the first attribute and the second attribute based on the acquired attribute value. Then, the random value identification device 100 generates the random number for each attribute in the random value range identified based on the identified correlation. Here, the random value range is a range in which the random number can be taken between the first attribute and the second attribute.

The random value range is based on the correlation between the first attribute specified by the external device or the like used by the user and the second attribute identified by the random value identification device 100 based on the first attribute. Therefore, the random value identification device 100 does not consider the correlation of all the attributes, but generates the random number based on the random value range identified based on the correlation between the second attribute identified so that the user permits disclosure like the first attribute and the first attribute.

There is a high possibility that the information on the attribute of which a certain user permits disclosure has a high possibility of being combined and used for data mining or the like in the future. However, when the random number is identified based on the random value range determined based on the consideration of the correlation about information of all attributes, the random value range specifies the random value to the attribute which is not considered at the time of data mining. Therefore, the validity of the data to which the random number in the random value range is added is decreased to the user who performs data mining.

On the other hand, in the random value identification device 100 according to the first exemplary embodiment, the random number is generated based on the random value range identified based on the correlation between the second attribute identified so that the user permits disclosure like the first attribute and the first attribute. Therefore, even when the random number included in the random value range is added to the attribute value, the value is converted into a value in a range in which it is expected that the user performs data mining. Therefore, the validity of the data after adding the random value can be maintained, and confidentiality of the original data can be maintained.

Accordingly, the random value identification device 100 according to the first exemplary embodiment can identify an appropriate random value which can conceal the value of the original data and increase the validity of the data after adding the random value.

For example, the technology described in non-patent document 1 calculates the random value based on the correlation value between all attributes. In other words, because the technology described in non-patent document 1 considers the correlation value between other attributes which have no correlation with the first attribute designated by the user, the random value range includes a range of data which is not suitable for data mining. As a result, the technology described in non-patent document 1 decreases the validity of data. Alternatively, because the technology described in patent document 1 does not consider the correlation between the attributes, the random value range includes a range of data which is not suitable for data mining. As a result, the technology described in patent document 1 decreases the validity of data.

On the other hand, the random value identification device 100 according to the first exemplary embodiment generates the random number based on the random value range identified based on the correlation between the second attribute identified so that the user permits disclosure like the first attribute and the first attribute. Therefore, even when the random number included in the random value range is added to the attribute value, the value is converted into a value in a range in which it is expected that the user performs data mining. Therefore, the validity of the data after adding the random value can be maintained, and confidentiality of the original data can be maintained. This is because a size corresponding to the size of the predetermined subspace which is identified based on range information stored by the random value identification device 100 is secured as the size of the random value range. Accordingly, the random value identification device 100 according to the first exemplary embodiment can identify an appropriate random value which can conceal the value of the original data and increase the validity of the data after adding the random value.

### Second Exemplary Embodiment

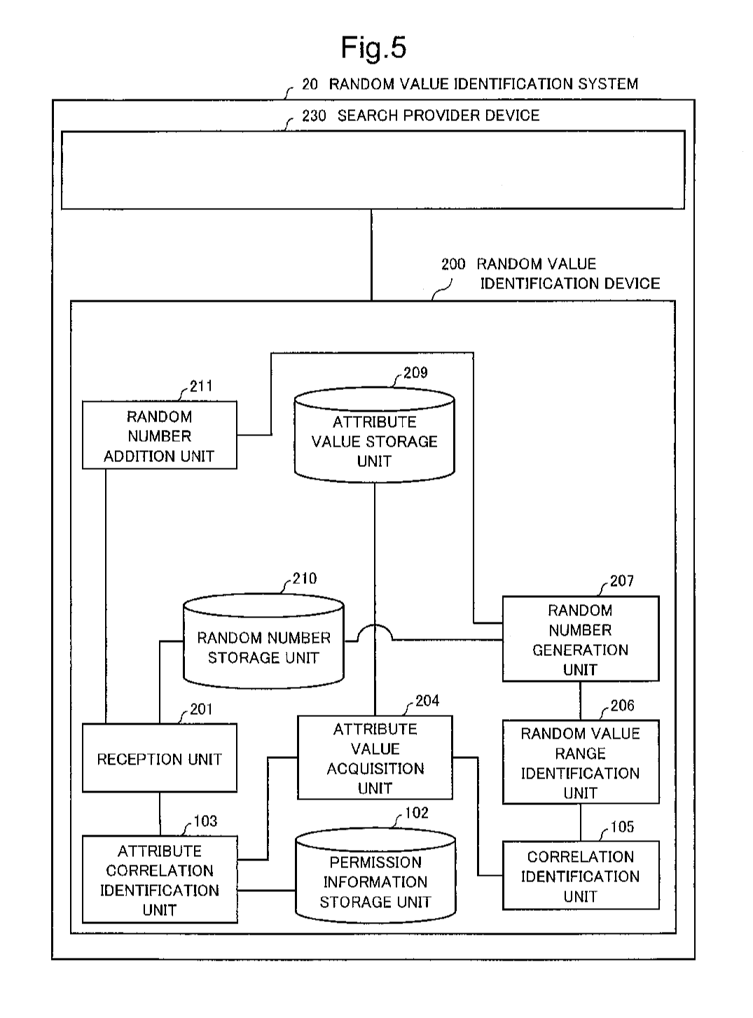

FIG. 5 is a block diagram showing a configuration of a random value identification system 20 according to a second exemplary embodiment of the present invention. Referring to FIG. 5, the random value identification system 20 according to the second exemplary embodiment includes a search provider device 230 and a random value identification device 200.

<Search Provider Device 230>

The search provider device 230 transmits the user identifier and the attribute name indicating the attribute of the information related to the user to the random value identification device 200 described later. The search provider device 230 may receive the user identifier from an external device which is not shown in the figure, or may include a user information storage unit which is not shown in the figure and stores the user identifier and read the user identifier stored in the user information storage unit. When the search provider device 230 receives the attribute value to which the random value is added, it outputs the received attribute value.

<Random Value Identification Device 200>

The random value identification device 200 includes a reception unit 201, the permission information storage unit 102, the attribute correlation identification unit 103, an attribute value acquisition unit 204, the correlation identification unit 105, a random value range identification unit 206, a random number generation unit 207, an attribute value storage unit 209, a random value storage unit 210, and a random number addition unit 211.

===Attribute Value Storage Unit 209===

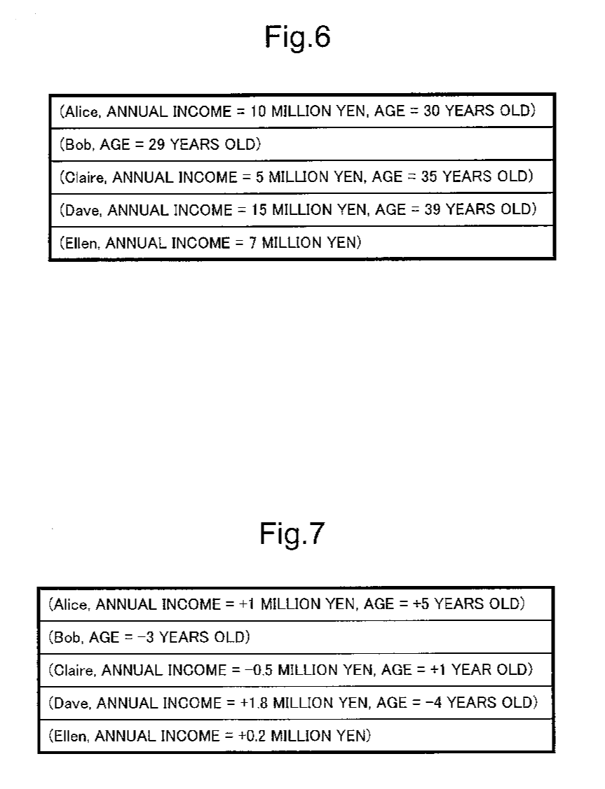

The attribute value storage unit 209 stores the user identifier, the attribute name, and the attribute value so that they are associated. This attribute value is an attribute value related to the user identified by the user identifier associated with this attribute value. And, this attribute name is information indicating the attribute corresponding to the attribute value associated with this attribute name. FIG. 6 is a figure showing an example of information stored by the attribute value storage unit 209. Referring to FIG. 6, for example, the attribute value storage unit 209 stores the user identifier “Alice”, the attribute name “annual income” and its attribute value “10 million yen”, and the attribute name “age” and its attribute value “30 years old” so that they are associated.

===Random Value Storage Unit 210===

The random value storage unit 210 stores the user identifier, the attribute name, and the random value added to the attribute value of the attribute indicated by the attribute name so that they are associated. FIG. 7 is a figure showing an example of information stored by the random value storage unit 210. Referring to FIG. 7, for example, the random value storage unit 210 stores the user identifier “Alice”, the attribute name “annual income” and its random value “+1 million yen”, and the attribute name “age” and its random value “+5 years old” so that they are associated.

The random value storage unit 210 may further store the search range with the above-mentioned information so that they are associated.

===Reception Unit 201===

When the reception unit 201 receives the user identifier and the attribute name from the search provider device 230, it judges whether or not the user identifier and the attribute name which are received are stored in the random value storage unit 210 so that they are associated.

When the reception unit 201 judges that the user identifier and the attribute name which are received are not stored in the random value storage unit 210, it sends the user identifier and the attribute name which are received to the attribute correlation identification unit 103. On the other hand, when the reception unit 201 judges that the user identifier and the attribute name which are received are stored in the random value storage unit 210, it reads the random value associated with the user identifier and attribute name from the random value storage unit 210. Then, the reception unit 201 sends the received user identifier, the received attribute name, and the read random value to the random number addition unit 211 described later. In this case, a part or all of the process performed in the attribute correlation identification unit 103, the attribute value acquisition unit 204, the correlation identification unit 105, the random value range identification unit 206, and the random number generation unit 207 may be omitted.

===Attribute Value Acquisition Unit 204===

The attribute value acquisition unit 204 performs the following process for each permission information identified by the attribute correlation identification unit 103. Namely, the attribute value acquisition unit 204 acquires the attribute value corresponding to the first attribute and the second attribute of the user who can be identified by the user identifier associated with the permission information from the attribute value storage unit 209.

Specifically, the attribute value acquisition unit 204 reads the attribute name and the attribute value which are associated with the user identifier associated with the permission information from the attribute value storage unit 209. Then, the attribute value acquisition unit 204 identifies the attribute value associated with the attribute name indicating the first attribute and the second attribute among the read attribute names, and acquires the attribute value.

===Random Value Range Identification Unit 206===

The random value range identification unit 206 identifies the random value range which is a range in which the random number can be taken between the first attribute and the second attribute corresponding to the correlation based on the correlation identified by the correlation identification unit 105.

The random value range identification unit 206 may store range information indicating a predetermined range for each attribute. Then, the random value range identification unit 206 may identify the random value range between the first attribute and the second attribute based on the range information corresponding to the first attribute and the second attribute, the attribute value, and the correlation identified by the correlation identification unit 105.

Specifically, the random value range identification unit 206 may identify the random value range by using the following process.

Firstly, the random value range identification unit 206 identifies the predetermined subspace which is a part of the space whose axes are the first attribute and the second attribute based on the range information corresponding to the first attribute and the second attribute.

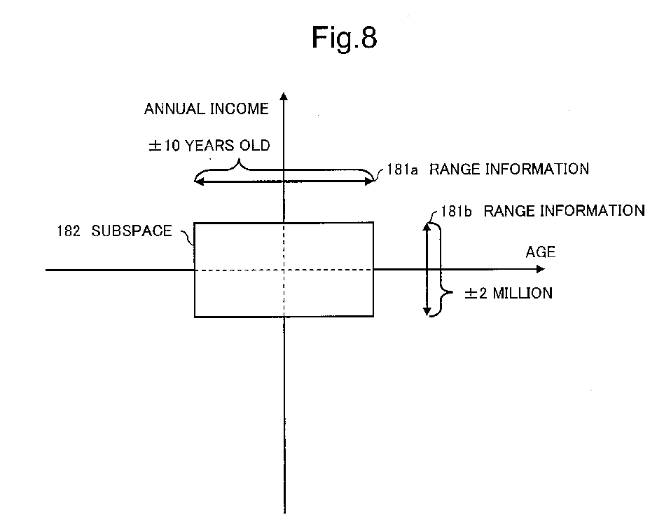

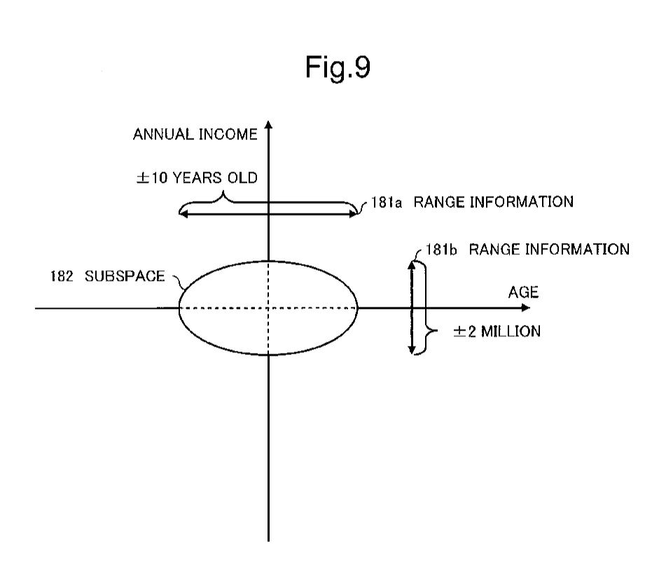

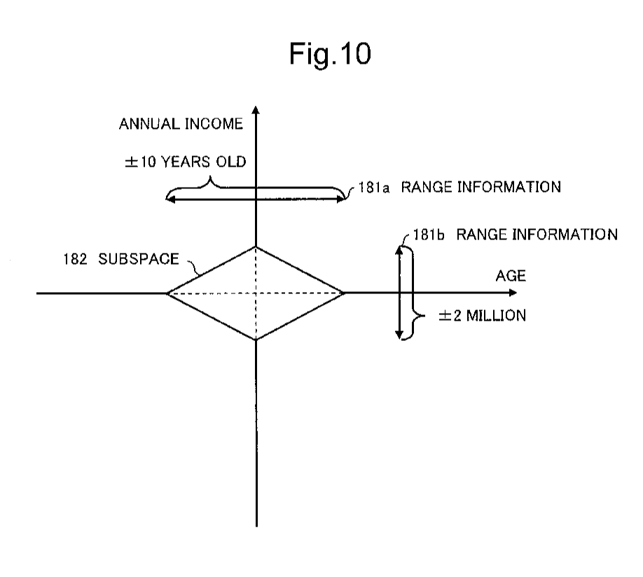

FIG. 8, FIG. 9, and FIG. 10 are figures showing an example of the predetermined subspace identified by the random value range identification unit 206. However, these figures are shown as an example, and the predetermined subspace is not limited to the shapes of examples. Referring to FIG. 8, FIG. 9, and FIG. 10, the random value range identification unit 206 stores a range information 181a about the attribute “age” and a range information 181b about the attribute “annual income” as the range information. The value of the range information 181a is “plus minus 10 years old”, and the value of the range information 181b is “plus minus 2 million”. Then, the random value range identification unit 206 identifies a predetermined subspace 182 based on these range information 181a and 181b.

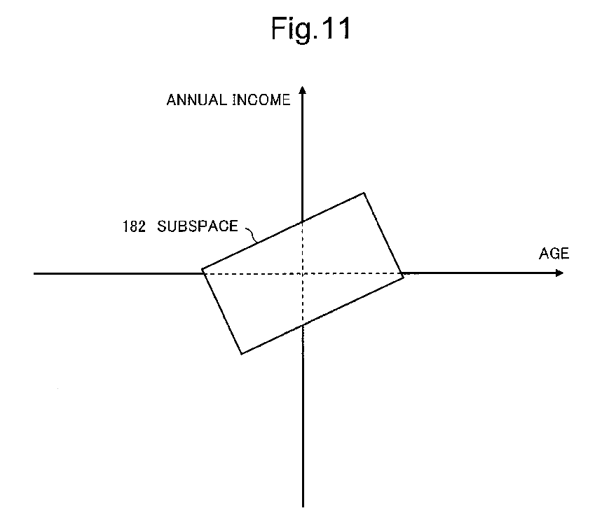

Secondly, the random value range identification unit 206 rotates the identified subspace based on the correlation coefficient calculated by the correlation identification unit 105. FIG. 11 is a figure showing an example in which the subspace 182 shown in FIG. 8 is rotated. The random value range identification unit 206 rotates the identified subspace by an angle θ based on a correlation coefficient r calculated by the correlation identification unit 105. However, the angle θ is a value calculated by using [Equation 1] described below. In [Equation 1], a is a predetermined constant number.

$$tan θ = \frac{r}{α} \qquad [ Equation 1 ]$$

When the number of the attributes is three or more, the above-mentioned angle θ or the correlation coefficient r is an angle or a function on a plane whose axes are two attributes. The random value range identification unit 206 selects two attributes among three or more attributes, and calculates the angle θ or the correlation coefficient r.

When the coordinates of the random value included in the predetermined subspace 182 in FIG. 8 is shown by the value indicated by [Equation 2], the coordinates of the random value which is mapped in the space rotated by the angle θ can be calculated by using [Equation 3].

$$\begin{matrix}( \begin{matrix}X \\ Y\end{matrix} ) & [ Equation 2 ] \\ ( \begin{matrix}{X}^{′} \\ {Y}^{′}\end{matrix} ) = ( \begin{matrix}cos θ & - sin θ \\ sin θ & cos θ\end{matrix} ) ( \begin{matrix}X \\ Y\end{matrix} ) & [ Equation 3 ]\end{matrix}$$

The random value range identification unit 206 identifies the subspace acquired by using the above-mentioned process as the random value range.

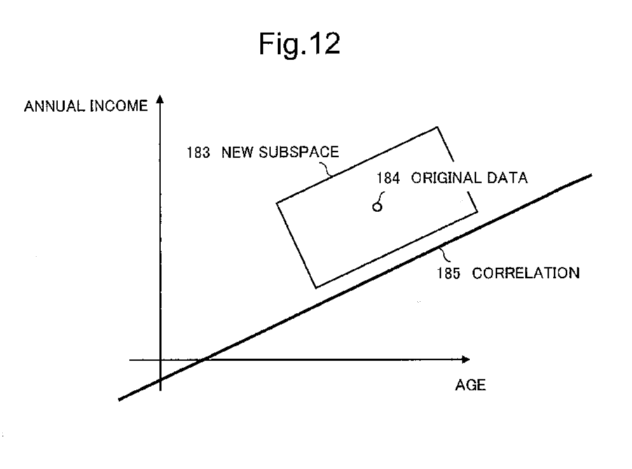

FIG. 12 is a figure showing certain attribute value, a range in which a value after adding the random number to the attribute value can be taken, and a function (correlation information 185) indicating the correlation between the attribute “age” and “annual income”. Referring to FIG. 12, original data 184 which is data of the original attribute value is converted into one of values in a new subspace 183 by adding the random value. The size of the range of the value in which the data after conversion can be taken is the same as the size of a new subspace 183 shown in FIG. 12. Therefore, a possibility that the original data is decrypted from the data after conversion depends on the size of the new subspace 183. When the size of this new subspace 183 is sufficiently large, the security of the original data can be guaranteed. The size of this new subspace 183 depends on the range information stored by the random value range identification unit 206.

The random value range identification unit 206 may generate the range information based on information received from the outside, and store the generated range information. For example, when the reception unit 201 receives the area information indicating a range of the attribute value of the attribute corresponding to the attribute name together with the attribute name, the random value range identification unit 206 stores the value of the area information as the range information of the attribute indicated by the attribute name.

When the correlation coefficient calculated based on the correlation identified by the correlation identification unit 105 shows equal to or greater than a predetermined threshold value, the random value range identification unit 206 may identify the above-mentioned random value range. This process is a process for guaranteeing whether or not the first attribute and the second attribute have a correlation between the attribute values.

===Random Number Generation Unit 207===

The random number generation unit 207 generates the random number for each kind of corresponding attribute so that the random value is included in the random value range identified by the random value range identification unit 206.

The random number generation unit 207 stores the attribute name and the random value added to the attribute value of the attribute indicated by the attribute name in the random value storage unit 210 so that they are associated.

===Random Number Addition Unit 211===

The random number addition unit 211 receives the random value corresponding to each attribute which is generated by the random number generation unit 207. Or, the random number addition unit 211 receives the user identifier, the attribute name, and the random value from the reception unit 201. The random number addition unit 211 reads the attribute value corresponding to the attribute name received by the reception unit 201 among the attribute values associated with the user identifier received by the reception unit 201 from the attribute value storage unit 209. Then, the random number addition unit 211 adds the random value corresponding to the attribute indicated by the attribute name to each read attribute value. The random number addition unit 211 transmits each attribute value to which the random value is added to the search provider device 230.

The random value identification device 200 according to the second exemplary embodiment may receive the predetermined constant number α and the range information which are used by the random value range identification unit 206 from the search provider device 230. The user using the search provider device 230 can customize the random value range based on setting of these values, and identify an appropriate random value which can increase the validity of data after adding the random value.

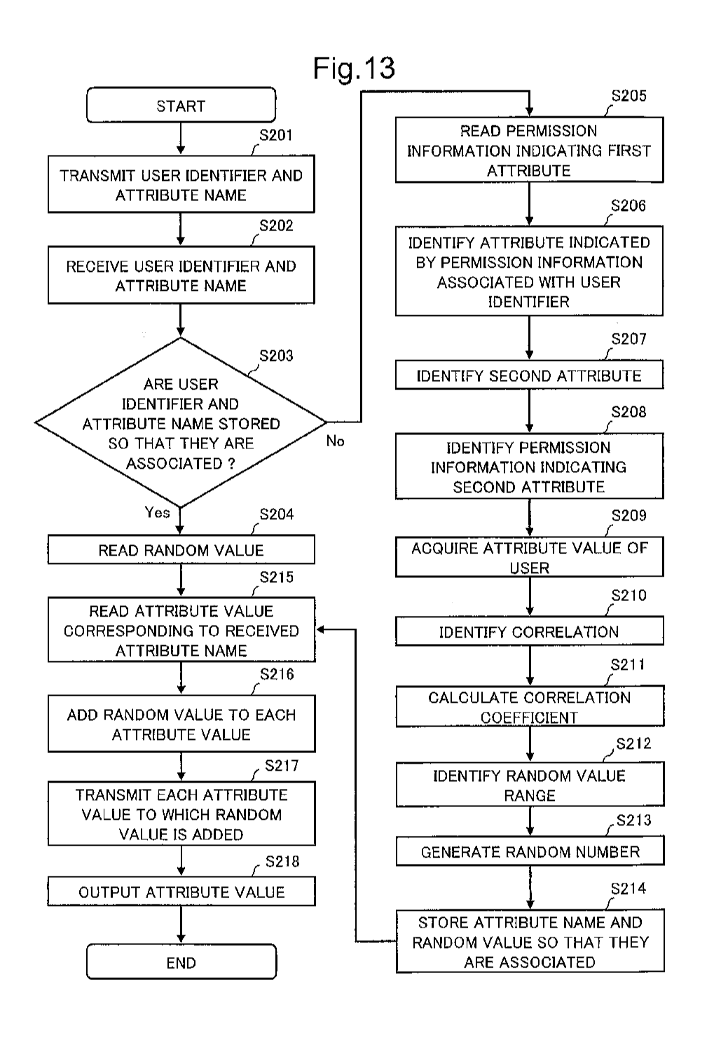

FIG. 13 is a flowchart showing an outline of operation of the random value identification system 20 according to the second exemplary embodiment.

The search provider device 230 transmits the user identifier and the attribute name related to the corresponding user to the random value identification device 200 (step S201). The user identifier and the attribute name may be determined based on the information received from an external device which is not shown in the figure.

The reception unit 201 receives the user identifier and the attribute name (step S202). The reception unit 201 judges whether or not the user identifier and the attribute name which are received are stored in the random value storage unit 210 so that they are associated (step S203). When the reception unit 201 judges that the user identifier and the attribute name which are received are not stored in the random value storage unit 210 (“No” in step S203), it sends the user identifier and the attribute name which are received to the attribute correlation identification unit 103. Then, the process of the random value identification system 20 proceeds to step S205.

On the other hand, when the reception unit 201 judges that the user identifier and the attribute name which are received are stored in the random value storage unit 210 (“Yes” in step S203), it performs the following process. Namely, the reception unit 201 reads the random value associated with the user identifier and the attribute name from the random value storage unit 210 (step S204). The reception unit 201 sends the received user identifier, the received attribute name, and the read random value to the random number addition unit 211. Then, the process of the random value identification system 20 proceeds to step S215.

In contrast, when the reception unit 201 judges that the user identifier and the attribute name which are received are not stored in the random value storage unit 210 (“No” in step S303), the random value identification system 20 operates as follows.

The attribute correlation identification unit 103 reads at least one permission information indicating the attribute (first attribute) indicated by the attribute name received by the reception unit 201 from the permission information storage unit 102 (step S205). The attribute correlation identification unit 103 identifies the attribute indicated by the permission information associated with the user identifier received by the reception unit 201 among the attributes indicated by the permission information read from the permission information storage unit 102 (step S206). The attribute correlation identification unit 103 identifies a certain attribute as the second attribute according to the cumulative total number indicated for each attribute based on each read permission information among the identified attributes (step S207).

The attribute correlation identification unit 103 identifies the permission information indicating the above-mentioned second attribute in the permission information read from the permission information storage unit 102 (step S208).

The attribute value acquisition unit 204 acquires the attribute value corresponding to the first attribute and the second attribute of the user who can be identified by the user identifier associated with the permission information for each permission information identified by the attribute correlation identification unit 103 from the attribute value storage unit 209 (step S209).

The correlation identification unit 105 identifies the correlation between the first attribute and the second attribute based on the attribute value acquired by the attribute value acquisition unit 204 (step S210). The correlation identification unit 105 calculates the correlation coefficient based on the identified correlation, and sends it to the random value range identification unit 206 (step S211).

The random value range identification unit 206 identifies the random value range which is a range in which the random number can be taken between the first attribute and the second attribute which correspond to the correlation based on the correlation identified by the correlation identification unit 105 (step S212). The random number generation unit 207 generates the random number for each corresponding attribute so that the random value is included in the random value range identified by the random value range identification unit 206 (step S213).

The random number generation unit 207 stores the attribute name and the random value added to the attribute value of the attribute indicated by the attribute name in the random value storage unit 210 so that they are associated (step S214).

The operations to here become the operations when it is judged that the user identifier and the attribute name which are received are not stored in the random value storage unit 210.

The operations after this become the same operations regardless of storage of the user identifier and the attribute name which are received.

The random number addition unit 211 receives the random value corresponding to each attribute which is generated by the random number generation unit 207. Or, the random number addition unit 211 receives the random value corresponding to each attribute from the reception unit 201. The random number addition unit 211 reads the attribute value corresponding to the attribute name received by the reception unit 201 among the attribute values associated with the user identifier received by the reception unit 201 from the attribute value storage unit 209 (step S215). Then, the random number addition unit 211 adds the random value corresponding to the attribute indicated by the attribute name to each read attribute value (step S216). The random number addition unit 211 transmits each attribute value to which the random value is added to the search provider device 230 (step S217).

When the search provider device 230 receives the attribute value to which the random value is added from the random value identification device 200, it outputs the received attribute value (step S218).

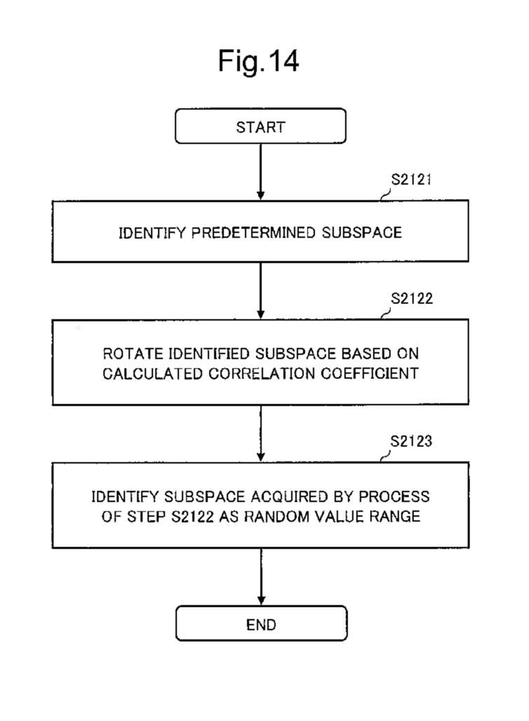

FIG. 14 is a flowchart showing an outline of operation of the random value range identification unit 206 according to the second exemplary embodiment.

The random value range identification unit 206 identifies the predetermined subspace which is a part of the space whose axes are the attributes based on the range information corresponding to the first attribute and the second attribute (step S2121).

The random value range identification unit 206 rotates the identified subspace based on the correlation coefficient calculated by the correlation identification unit 105 (step S2122).

The random value range identification unit 206 identifies the subspace acquired by using the process of step S2122 as the random value range (step S2123).

The random value identification system 20 according to the second exemplary embodiment includes elements provided in the random value identification device 100 according to the first exemplary embodiment. Accordingly, the random value identification system 20 according to the second exemplary embodiment has a similar effect of the random value identification device 100 according to the first exemplary embodiment.

And, the random value identification system 20 according to the second exemplary embodiment identifies other attribute permitted by the user based on the permission information indicating at least one attribute of which the user permits disclosure and the attribute name transmitted by the search provider device 230. Then, the random value identification system 20 identifies the correlation between the attribute identified by the attribute name and the above-mentioned other attribute, and identifies the random value range which is a range of the random value added to the attribute value based on the correlation.

For example, there is a case in which the search provider device 230 uses a plurality of search queries to search for one fact. For example, referring to FIG. 2, a case in which “age” and “annual income” of the user identifier “Alice” are searched is assumed. Here, for example, the search provider device 230 transmits the user identifier “Alice” and the attribute name “age” to the random value identification device 200. When the random value identification device 200 receives the user identifier “Alice” and the attribute name “age”, it reads the permission information of “Alice”, “Claire”, “Dave”, and “Ellen” from the permission information storage unit 102. Then, the random value identification device 200 calculates a cumulative total of the attribute indicated by each permission information for each attribute. For example, the random value identification device 200 identifies “annual income” whose calculated cumulative total is the maximum and which is the attribute indicated by the permission information associated with the user identifier “Alice” received by the reception unit 101 as the second attribute.

The random value identification device 200 identifies the correlation between the attribute “age” and “annual income”. The random value identification device 200 identifies the random value range based on the identified correlation. The random value identification device 200 identifies the random value included in any one of the identified random value ranges. Then, the random value identification device 200 stores the user identifier “Alice”, the attribute name “age”, and the random value in the random value storage unit 210 so that they are associated. And, the random value identification device 200 stores the user identifier “Alice”, the attribute name “annual income”, and the random value in the random value storage unit 210 so that they are associated.

The random value identification device 200 adds the above-mentioned random value to the attribute value of “age” of “Alice”, and returns it to the search provider device 230.

Next, the search provider device 230 transmits the user identifier “Alice” and the attribute name “annual income” to the random value identification device 200. In this case, the random value identification device 200 judges that the user identifier “Alice”, the attribute name “annual income”, and the predetermined random value are stored in the random value storage unit 210, adds the random value to the attribute value of “annual income” of “Alice”, and returns it to the search provider device 230.

Therefore, even when the plurality of search queries are used for searching for one fact related to a certain user as mentioned above, the random value identification system 20 according to the second exemplary embodiment can surmise the query after next time based on the search query of the first time. Further, the random value identification system 20 according to the second exemplary embodiment can identify the appropriate random value range based on the surmise result. In other words, the random value identification system 20 according to the second exemplary embodiment can identify the random value which can increase the validity of data after adding the random value.

[First Modification Example of the Second Exemplary Embodiment]

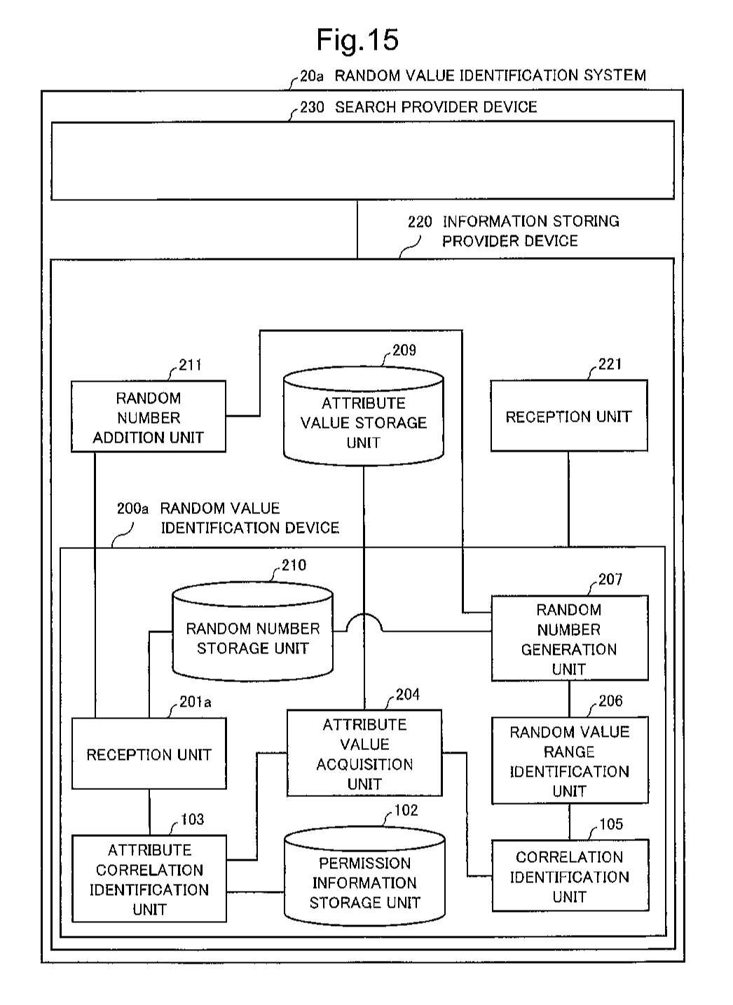

FIG. 15 is a block diagram showing a configuration of a random value identification system 20a according to a first modification example of the second exemplary embodiment of the present invention. Referring to FIG. 15, the random value identification system 20a includes a search provider device 230a and an information storing provider device 220.

<Search Provider Device 230a>

The search provider device 230a transmits the user identifier and the attribute name indicating the attribute of information related to the user to the information storing provider device 220 described later. The search provider device 230a may receive the user identifier from an external device which is not shown in the figure, or may include a user information storage unit which is not shown in the figure for storing the user identifier and read the user identifier stored in the user information storage unit.

When the search provider device 230a receives the attribute value to which the random value is added, it outputs the received attribute value.

<Information Storing Provider Device 220>

The information storing provider device 220 includes a random value identification device 200a, a reception unit 221, the attribute value storage unit 209, and the random number addition unit 211.

===Reception Unit 221===

The reception unit 221 receives the user identifier and the attribute name, and sends the user identifier and the attribute name which are received to the random value identification device 200a.

<Random Value Identification Device 200a>

The random value identification device 200a includes a reception unit 201a, the permission information storage unit 102, the attribute correlation identification unit 103, the attribute value acquisition unit 204, the correlation identification unit 105, the random value range identification unit 206, the random number generation unit 207, and the random value storage unit 210.

===Reception Unit 201a===

The reception unit 201a receives the user identifier and the attribute name from the reception unit 221, and sends the user identifier and the attribute name which are received to the attribute correlation identification unit 103.

The random value identification system 20a according to the first modification example of the second exemplary embodiment includes similar elements of the random value identification system 20 according to the second exemplary embodiment. Accordingly, the random value identification system 20a according to the first modification example of the second exemplary embodiment has a similar effect of the random value identification system 20 according to the second exemplary embodiment.

[Second Modification Example of the Second Exemplary Embodiment]

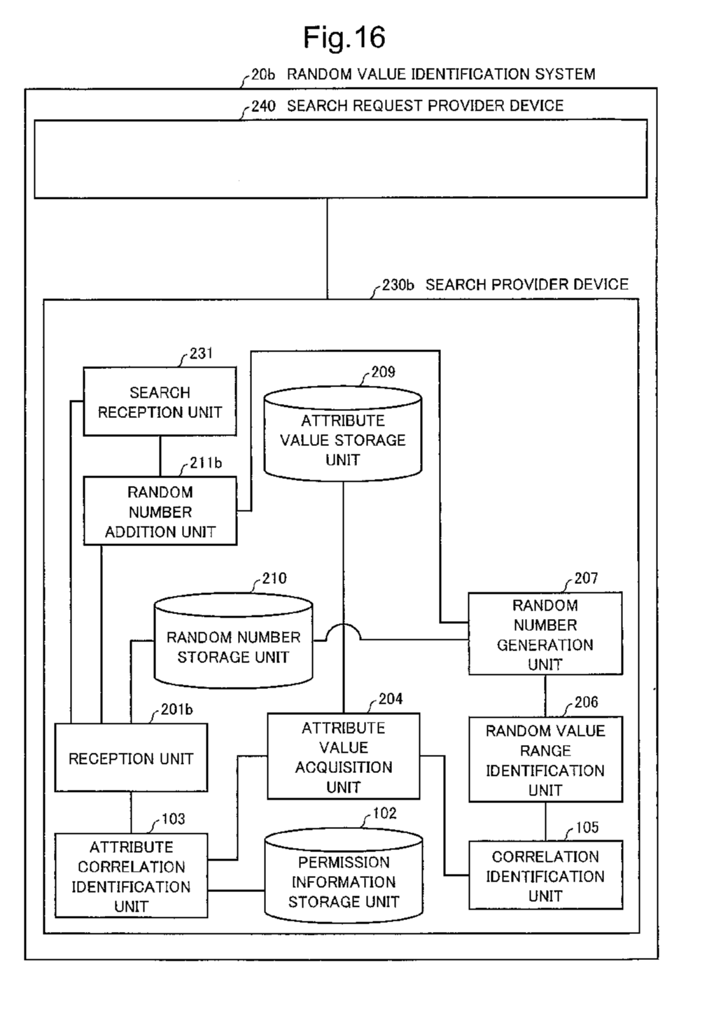

FIG. 16 is a block diagram showing a configuration of a random value identification system 20b according to a second modification example of the second exemplary embodiment of the present invention. Referring to FIG. 16, the random value identification system 20b includes a search request provider device 240 and a search provider device 230b.

<Search Request Provider Device 240>

The search request provider device 240 transmits the search range indicating a range of a certain attribute value to the search provider device 230b. The search request provider device 240 may transmit the user identifier which is information which can identify the user to the search provider device 230b.

When the search request provider device 240 receives the attribute value to which the random value is added, it outputs the received attribute value to each user corresponding to each attribute value.

<Search Provider Device 230b>

The search provider device 230b includes a search reception unit 231, a reception unit 201b, the permission information storage unit 102, the attribute correlation identification unit 103, the attribute value acquisition unit 204, the correlation identification unit 105, the random value range identification unit 206, the random number generation unit 207, the random value storage unit 210, a random number addition unit 211b, and the attribute value storage unit 209.

===Search Reception Unit 231===

The search reception unit 231 receives the search range indicating a range of a certain attribute value from the search request provider device 240. Then, the search reception unit 231 sends the received search range, the user identifier which can identify the user, and the attribute name indicating the attribute of the information related to the user to the reception unit 201b described later. This attribute name is an attribute name indicating the attribute corresponding to the attribute value indicated by the received search range.

The search reception unit 231 may receive the user identifier from the search request provider device 240, or may include a user information storage unit which is not shown in the figure for storing the user identifier and read the user identifier stored in the user information storage unit.

The search reception unit 231 may send all the user identifiers received from the search request provider device 240 to the reception unit 201b. Or, the search reception unit 231 may send all the user identifiers stored in the user information storage unit to the reception unit 201b.

When the search reception unit 231 receives the attribute value to which the random value is added from the random number addition unit 211b, it performs the following process for each user corresponding to each attribute value. First, the search reception unit 231 identifies the attribute corresponding to a range of the attribute value indicated by the search range received from the search request provider device 240. Then, the search reception unit 231 transmits the attribute value to which the random value of the user of whom all the attribute values corresponding to the identified attribute are ready is added to the search request provider device 240.

The process in which the search reception unit 231 sends the user identifier to the reception unit 201b may be performed whenever the search range is received from the search request provider device 240 or may be performed independently of the process of receiving the search range from the search request provider device 240.

===Reception Unit 201b===

The reception unit 201b receives the user identifier and the attribute name from the search reception unit 231, and sends the user identifier and the attribute name to the attribute correlation identification unit 103.

===Random Number Addition Unit 211b===

The random number addition unit 211b receives the random value corresponding to each attribute which is generated by the random number generation unit 207. Or, the random number addition unit 211b receives the user identifier, the attribute name, and the random value from the reception unit 201b. The random number addition unit 211b reads the attribute value corresponding to the attribute name received by the reception unit 201b among the attribute values associated with the user identifier received by the reception unit 201b from the attribute value storage unit 209. Then, the random number addition unit 211b adds the random value corresponding to the attribute indicated by the attribute name to each read attribute value. The random number addition unit 211b sends each attribute value to which the random value is added to the search reception unit 231.

The random value identification system 20b according to the second modification example of the second exemplary embodiment includes similar elements of the random value identification system 20 according to the second exemplary embodiment. Accordingly, the random value identification system 20b according to the second modification example of the second exemplary embodiment has a similar effect of the random value identification system 20 according to the second exemplary embodiment.

### Third Exemplary Embodiment

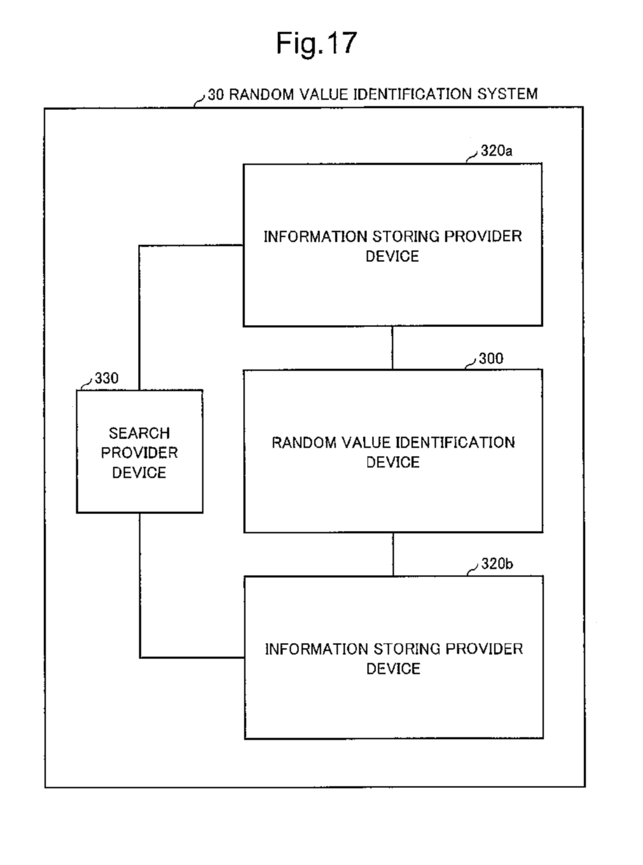

FIG. 17 is a block diagram showing a configuration of a random value identification system 30 according to a third exemplary embodiment of the present invention. Referring to FIG. 17, the random value identification system 30 includes a search provider device 330, an information storing provider device 320a, an information storing provider device 320b, and a random value identification device 300.

In the third exemplary embodiment, an information storing provider device 320 is a generic name of the information storing provider devices 320a and 320b.

<Search Provider Device 330>

The search provider device 330 transmits the user identifier and the attribute name of the attribute of the information related to the user to the information storing provider device 320a and the information storing provider device 320b which are described later. The search provider device 330 may receive the user identifier from an external device which is not shown in the figure, or may include a user information storage unit which is not shown in the figure for storing the user identifier and read the user identifier stored in the user information storage unit.

And, the search provider device 330 may transmit a public key generated by the search provider device 330 to the information storing provider device 320. This public key is a public key of the fully homomorphic encryption.

When the search provider device 330 receives the attribute value to which the random value is added, it outputs the received attribute value. And, when the search provider device 330 receives the encrypted attribute value to which the random value is added, it decrypts the received attribute value by using a secret key of the fully homomorphic encryption corresponding to the above-mentioned public key. Then, the search provider device 330 outputs the decrypted attribute value.

In the third exemplary embodiment, the search provider device 330 may transmit the public key when it transmits the user identifier and the attribute name to the information storing provider device 320, or may transmit the public key to the information storing provider device 320 in advance.

<Information Storing Provider Device 320>

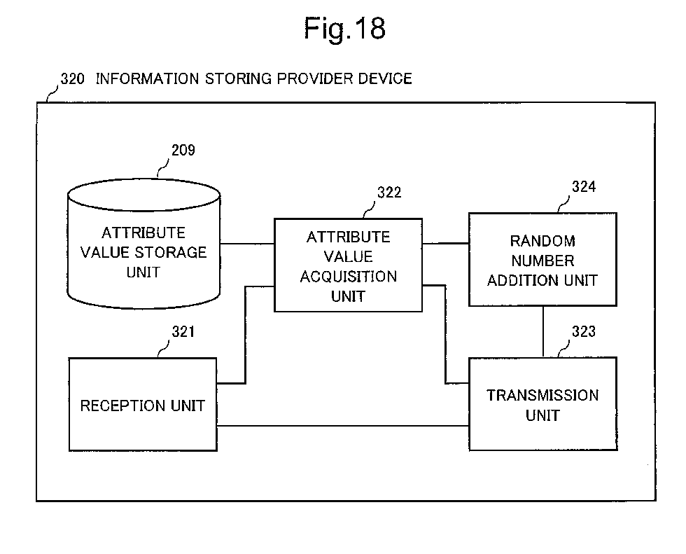

FIG. 18 is a block diagram showing a configuration of the information storing provider device 320 according to the third exemplary embodiment of the present invention. Referring to FIG. 18, the information storing provider device 320 includes a reception unit 321, the attribute value storage unit 209, an attribute value acquisition unit 322, a transmission unit 323, and a random number addition unit 324.

===Reception Unit 321===

The reception unit 321 receives the user identifier and the attribute name from the search provider device 330. Then, the reception unit 321 transmits the received attribute name to the random value identification device 300.

When the reception unit 321 receives the public key generated by the search provider device 330 from the search provider device 330, it sends the received public key to the transmission unit 323.

===Attribute Value Acquisition Unit 322===

The attribute value acquisition unit 322 receives the user identifier and the attribute name from the random value identification device 300. Then, the attribute value acquisition unit 322 acquires the attribute value associated with the received user identifier and the received attribute name from the attribute value storage unit 209.

The attribute value acquisition unit 322 sends the acquired attribute value, the received user identifier, and the received attribute name to the transmission unit 323.

===Transmission Unit 323===

The transmission unit 323 receives the user identifier, the attribute name, and the attribute value from the attribute value acquisition unit 322, and transmits the user identifier, the attribute name, and the attribute value which are received to the random value identification device 300.

The transmission unit 323 may encrypt the attribute value with a predetermined encryption and transmit it to the random value identification device 300. For example, the transmission unit 323 encrypts the attribute value by using the public key of the fully homomorphic encryption which is generated by the search provider device 330. Then, the transmission unit 323 transmits the encrypted attribute value to the random value identification device 300. The random value identification device 300 can perform an addition operation and a multiplication operation to the encrypted data with the fully homomorphic encryption without a plain text or the secret key. In other words, the random value identification device 300 can perform an operation of the random value by using the encrypted attribute value while the attribute value is encrypted. In the third exemplary embodiment, it is assumed that the transmission unit 323 encrypts the attribute value by using the fully homomorphic encryption.

===Random Number Addition Unit 324===

The random number addition unit 324 receives the random value from the random value identification device 300. The random number addition unit 324 adds the random value of the attribute corresponding to the attribute value to the attribute value acquired by the attribute value acquisition unit 322.

When the random number addition unit 324 receives information indicating that the attribute value is encrypted together with the random value, it performs the following process. Namely, the random number addition unit 324 performs the addition operation of the received encrypted random value and the received encrypted attribute value while they are encrypted. This process of addition operation is performed by using an algorithm corresponding to the encryption process applied to the attribute value by the transmission unit 323.

The random number addition unit 324 transmits the attribute value to which the random value is added to the search provider device 330. And, when the attribute value is encrypted, the random number addition unit 324 transmits the encrypted attribute value to which the random value is added to the search provider device 330.

<Random Value Identification Device 300>

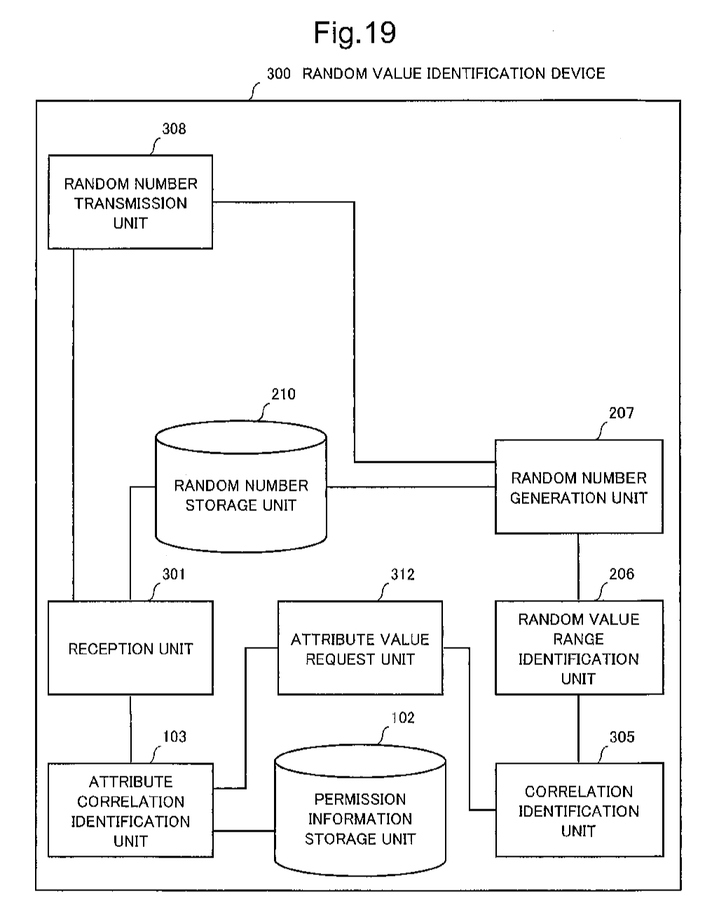

FIG. 19 is a block diagram showing a configuration of the random value identification device 300 according to the third exemplary embodiment of the present invention. Referring to FIG. 19, the random value identification device 300 includes a reception unit 301, the permission information storage unit 102, the attribute correlation identification unit 103, a correlation identification unit 305, the random number generation unit 207, an attribute value request unit 312, the random value range identification unit 206, a random number transmission unit 308, and the random value storage unit 210.

===Reception Unit 301===

When the reception unit 301 receives the user identifier and the attribute name from the information storing provider device 320, it judges whether or not the user identifier and the attribute name which are received are stored in the random value storage unit 210 so that they are associated.

When the reception unit 301 judges that the user identifier and the attribute name which are received are not stored in the random value storage unit 210, it sends the user identifier and the attribute name which are received to the attribute correlation identification unit 103. On the other hand, when the reception unit 301 judges that the user identifier and the attribute name which are received are stored in the random value storage unit 210, it reads the random value associated with the user identifier and attribute name from the random value storage unit 210. Then, the reception unit 301 sends the received user identifier, the received attribute name, and the read random value to the random number transmission unit 308 described later. In this case, a part or all of the process performed in the attribute correlation identification unit 103, the attribute value request unit 312, the correlation identification unit 305, the random value range identification unit 206, and the random number generation unit 207 may be omitted.

===Attribute Value Request Unit 312===

The attribute value request unit 312 performs the following process for each permission information identified by the attribute correlation identification unit 103. Namely, the attribute value request unit 312 transmits the user identifier associated with the permission information and the attribute value indicating the first attribute and the second attribute of the user identified by the user identifier to the information storing provider device 320. The first attribute is the attribute indicated by the attribute name received by the reception unit 301. And, the second attribute is the predetermined attribute identified by the attribute correlation identification unit 103.

===Correlation Identification Unit 305===

The correlation identification unit 305 identifies the correlation between the first attribute and the second attribute based on the attribute value received from the information storing provider device 320. The process in which the correlation identification unit 305 specifically evaluates the correlation is similar to the process of the correlation identification unit 105 according to the first exemplary embodiment.

Even when the attribute value received from the information storing provider device 320 is encrypted, the correlation identification unit 305 can evaluate the correlation by a similar process of the correlation identification unit 105 according to the first exemplary embodiment. The reason is because the attribute value is encrypted by using the fully homomorphic encryption.

===Random Number Transmission Unit 308===

The random number transmission unit 308 receives the random value generated by the random number generation unit 207 or the random value read from the random value storage unit 210 by the reception unit 301. The random number transmission unit 308 transmits the received random value to the information storing provider device 320. In particular, the random number transmission unit 308 transmits the random value added to the attribute corresponding to the attribute value received by the reception unit 301 to the information storing provider device 320.

When the attribute value received by the reception unit 301 is encrypted, the random number transmission unit 308 transmits the information indicating that the attribute value is encrypted to the information storing provider device 320 accordingly.

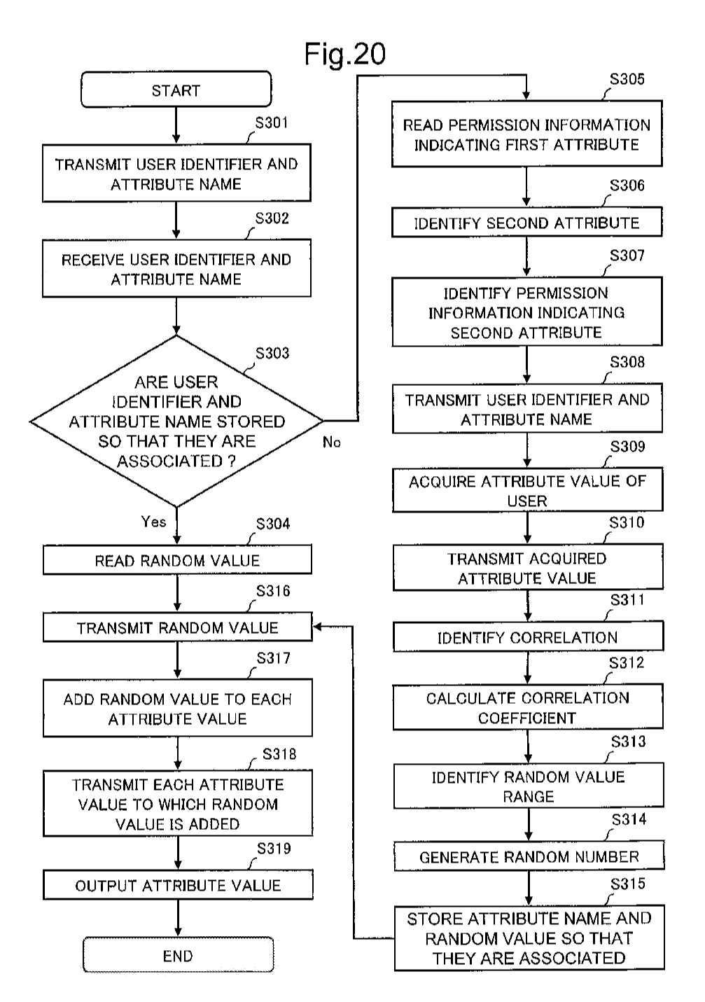

FIG. 20 is a flowchart showing an outline of operation of the random value identification system 30 according to the third exemplary embodiment. The operation of FIG. 20 is an example of a case in which the search provider device 330 transmits the user identifier and the attribute name to the information storing provider device 320a.

The search provider device 330 transmits the user identifier and the attribute name of the attribute of the information related to the user to the information storing provider device 320a (step S301). The reception unit 321 of the information storing provider device 320a receives the user identifier and the attribute name from the search provider device 330 (step S302). The reception unit 321 transmits the user identifier and the attribute name which are received to the random value identification device 300.

The reception unit 301 of the random value identification device 300 receives the user identifier and the attribute name. Then, the reception unit 301 judges whether or not the user identifier and the attribute name which are received are stored in the random value storage unit 210 so that they are associated (step S303). When the reception unit 301 judges that the user identifier and the attribute name which are received are not stored in the random value storage unit 210 (“No” in step S303), it sends the user identifier and the attribute name which are received to the attribute correlation identification unit 103. Then, the process of the random value identification system 30 proceeds to step S305.

On the other hand, when the reception unit 301 judges that the user identifier and the attribute name which are received are stored in the random value storage unit 210 (“Yes” in step S303), it performs the following process. Namely, the reception unit 301 reads the random value associated with the user identifier and attribute name from the random value storage unit 210 (step S304). The reception unit 301 sends the received user identifier, the received attribute name, and the read random value to the random number transmission unit 308. Then, the process of the random value identification system 30 proceeds to step S316.

In contrast, when it is judged that the user identifier and the attribute name which are received are not stored in the random value storage unit 210, the random value identification system 30 operates as follows.

The attribute correlation identification unit 103 reads at least one permission information indicating the attribute (first attribute) indicated by the attribute name received by the reception unit 301 from the permission information storage unit 102 (step S305). Then, the attribute correlation identification unit 103 identifies the second attribute according to the cumulative total number indicated for each attribute among the attributes indicated by the permission information read from the permission information storage unit 102 (step S306). Then, the attribute correlation identification unit 103 identifies the permission information indicating the second attribute in the permission information read in the process of step S305 (step S307).

The attribute value request unit 312 performs the following process for each permission information identified in the process of step S307. Namely, the attribute value request unit 312 transmits the user identifier associated with the permission information and the attribute name indicating the first attribute and the second attribute of the user identified by the user identifier to the information storing provider device 320a (step S308).

The attribute value acquisition unit 322 of the information storing provider device 320a receives the user identifier and the attribute name from the random value identification device 300. Then, the attribute value acquisition unit 322 acquires the attribute value associated with the attribute name and the user identifier for each received attribute name from the attribute value storage unit 209 (step S309). The transmission unit 323 transmits the attribute value acquired by the attribute value acquisition unit 322 to the random value identification device 300 (step S310).

The random value identification device 300 receives the attribute value from the information storing provider device 320a. Then, the correlation identification unit 305 identifies the correlation between the first attribute and the second attribute based on the above-mentioned attribute value (step S311). The correlation identification unit 305 calculates the correlation coefficient based on the identified correlation, and sends it to the random value range identification unit 206 (step S312).

The random value range identification unit 206 identifies the random value range which is a range in which the random number can be taken between the first attribute and the second attribute corresponding to the correlation based on the correlation identified by the correlation identification unit 305 (step S313). The random number generation unit 207 generates the random number for each corresponding attribute so that the random value is included in the random value range identified by the random value range identification unit 206 (step S314).

The random number generation unit 207 stores the attribute name and the random value added to the attribute value of the attribute indicated by the attribute name in the random value storage unit 210 so that they are associated (step S315).

The operations to here become the operations when it is judged that the user identifier and the attribute name which are received are not stored in the random value storage unit 210.

The operations after this become the same operations regardless of storage of the user identifier and the attribute name which are received are stored.

The random number transmission unit 308 receives the random value corresponding to each attribute which is generated by the random number generation unit 207. Or, the random number addition unit 211 receives the random value corresponding to each attribute from the reception unit 301. The random number transmission unit 308 transmits the received random value to the information storing provider device 320a (step S316).

The random number addition unit 324 of the information storing provider device 320a receives the random value from the random value identification device 300. The random number addition unit 324 adds the random value of the attribute corresponding to the attribute value to the attribute value acquired by the attribute value acquisition unit 322 (step S317).

The random number addition unit 324 transmits the attribute value to which the random value is added to the search provider device 330 (step S318). When the search provider device 330 receives the attribute value to which the random value is added, it outputs the received attribute value (step S319). Then, the process of the random value identification system 30 ends.

The random value identification system 30 according to the third exemplary embodiment includes similar elements of the random value identification system 20 according to the second exemplary embodiment. Accordingly, the random value identification system 30 according to the first modification example of the third exemplary embodiment has a similar effect of the random value identification system 20 according to the second exemplary embodiment.

And, the random value identification device 300 according to the third exemplary embodiment identifies the correlation and the random value range based on the value of the encrypted attribute value without knowing a true value of the attribute value. By using the fully homomorphic encryption as an encryption algorithm, the random value identification device 300 can perform the addition and the multiplication to the encrypted data without knowing the plain text and the secret key used for the encryption.

The random value identified based on the random value range identified by the random value identification device 300 is transmitted to the information storing provider device 320. Then, the information storing provider device 320 adds the encrypted random value to the encrypted attribute value as it is. The information storing provider device 320 transmits the encrypted attribute value to which the random value is added to the search provider device 330.

The search provider device 330 decrypts the received attribute value by using the secret key generated by the search provider device 330, and outputs the decrypted attribute value.

Accordingly, the random value identification system 30 according to the third exemplary embodiment can identify an appropriate random value which can conceal the value of the original data and can increase the validity of the data after adding the random value. In particular, the random value identification system 30 can identify the appropriate random value which can increase the validity of the data after adding the random value without the random value identification device 300 knowing the value of the original data.

An example of the effect of the present invention is to be able to identify an appropriate random value by which the value of original data can be concealed and the validity of data after adding the random value can be increased.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

And, each element according to each exemplary embodiment of the present invention can be realized by a computer and a program as well ad hardware realization of function. The program is provided by recording in a computer-readable recording medium such as a magnetic disc, a semiconductor memory, or the like, and is read to computer at the time of booting or the like. This read program controls the operation of the computer and makes the computer function elements according to each exemplary embodiment mentioned above.

This application is based upon and claims the benefit of priority from Japanese patent application No. 2011-047929, filed on Mar. 4, 2011, the disclosure of which is incorporated herein in its entirety by reference.

### INDUSTRIALLY APPLICATION

The random value identification device of the present invention can be applied to an information processing device which realizes privacy protection data mining.

### DESCRIPTION OF SYMBOL

100 random value identification device
101 reception unit
102 permission information storage unit
103 attribute correlation identification unit
104 attribute value acquisition unit
105 correlation identification unit
107 random number generation unit
181a range information
181b range information
182 subspace
183 new subspace
184 original data
185 correlation information
191 CPU
192 communication interface
193 memory
194 storage device
195 input device
196 output device
197 bus
198 recording medium
200 random value identification device
201 reception unit
204 attribute value acquisition unit
206 random value range identification unit
207 random number generation unit
209 attribute value storage unit
210 random value storage unit
211 random number addition unit
220 information storing provider device
221 reception unit
230 search provider device
231 search reception unit
200a random value identification device
20 random value identification system
20a random value identification system
201a reception unit
20b random value identification system
230b search provider device
201b reception unit
211b random number addition unit
30 random value identification system
300 random value identification device
320a information storing provider device
320b information storing provider device
330 search provider device
321 reception unit
322 attribute value acquisition unit
323 transmission unit
324 random number addition unit
305 correlation identification unit
301 reception unit
308 random number transmission unit
312 attribute value request unit

1. A random value identification device comprising:
a permission information storage unit which stores permission information indicating an attribute of which a user permits;
a reception unit which receives a first attribute related to the user;
an attribute correlation identification unit which identifies an attribute which is disclosed and has strong correlation with the first attribute as a second attribute based on permission information of the user who permits the discloser of the first attribute among permission information stored in said permission information storage;
a correlation identification unit which identifies a correlation between the first attribute and the second attribute based on the acquired attribute value of the first attribute and the second attribute; and
a range identification unit which identifies a range in which a random number can be taken between the first attribute and the second attribute which are identified based on the correlation.

2. The random value identification device according to claim 16, wherein
said random number generation unit generates the random number when a correlation coefficient calculated based on the correlation identified by said correlation identification unit is equal to or greater than a predetermined threshold value.

3. The random value identification device according to claim 1, wherein
said reception unit receives the user identifier; and
said attribute correlation identification unit identifies the second attribute among the attributes indicated by the permission information associated with the user identifier.

4. The random value identification device according to claim 3, wherein
said attribute correlation identification unit identifies the attribute when a cumulative total number indicated for the attribute is equal to or greater than a predetermined number among the attributes indicated by the permission information read from said permission information storage unit as the second attribute.

5. The random value identification device according to claim 1, wherein
said attribute correlation identification unit identifies attributes of a predetermined number sequentially from the way with much cumulative total number indicated for each attribute among the attributes indicated by the permission information read from said permission information storage unit as the second attribute.

6. The random value identification device according to claim 1, wherein
said reception unit receives the user identifier; and
said attribute correlation identification unit identifies the permission information indicating the attributes whose number is equal to or greater than the predetermined number among the attributes indicated by the permission information associated with the user identifier in the permission information read from said permission information storage unit, and identifies the second attribute according to the cumulative total number indicated for each attribute among the attributes indicated by the identified permission information.

7. The random value identification device according to claim 1, wherein
said reception unit receives the user identifier; and
said attribute correlation identification unit calculates a common degree indicating a commonality between the attribute indicated by the permission information associated with the user identifier and the attribute indicated by the permission information read from said permission information storage unit, identifies the permission information whose common degree is equal to or greater than the predetermined value in the permission information read from said permission information storage unit, and identifies the second attribute according to the cumulative total number indicated for each attribute among the attributes indicated by the identified permission information.

8. The random value identification device according to claim 16, comprising:
a random value storage unit which stores the attribute name and the random value so that they are associated; wherein
said random number generation unit stores the generated random value and the attribute name indicating the attribute to which the random number is added to said random value storage unit so that they are associated; and
said reception unit identifies the random value which is stored in said random value storage unit associated with the attribute name as the random value added to the attribute value of the attribute indicated by the attribute name when the attribute name to be received is stored in said random value storage unit.

9. The random value identification device according to claim 1, wherein
at least one of the first attributes and the second attributes is plural.

10. A random value identification system comprising: a search provider device; and a random value identification device; wherein
said search provider device comprising:
a query transmission unit which transmits an attribute name indicating a first attribute of information related to a user to said random value identification device; and
said random value identification device comprising:
an attribute value storage unit which stores the attribute name and an attribute value so that they are associated;
a permission information storage unit which stores permission information indicating an attribute of which the user permits disclosure;
a reception unit which receives the attribute name from said search provider device;
an attribute correlation identification unit which identifies an attribute which is disclosed and has strong correlation with the first attribute as a second attribute based on permission information of the user who permits the discloser of the first attribute among permission information stored in said permission information storage;
an attribute value acquisition unit which acquires the attribute value which is stored and associated with the first attribute and the second attribute of the user associated with the permission information for each the identified permission information from said attribute value storage unit;
a correlation identification unit which identifies a correlation between the first attribute and the second attribute based on the acquired attribute value;
a range identification unit which identifies a range in which a random number can be taken between the first attribute and the second attribute which are identified based on the correlation;
a random number generation unit which generates the random number for each attribute in the range identified by said range identification unit;
a random number addition unit which adds the generated random value to the attribute value of the corresponding attribute; and
a transmission unit which transmits information to which the random value is added to said search provider device.

11. A random value identification system comprising: a search provider device; an information storing provider device; and a random value identification device; wherein
said search provider device comprising:
a query transmission unit which transmits an attribute name indicating a first attribute of information related to a user to said information storing provider device;
said information storing provider device comprising:
an attribute value storage unit which stores the attribute name and an attribute value so that they are associated;
a reception unit which receives the attribute name from said search provider device, and transmits the attribute name to said random value identification device;
an attribute value acquisition unit which acquires the attribute value associated with the attribute name received from said random value identification device from said attribute value storage unit;
a transmission unit which transmits the attribute value to said random value identification device; and
a random number addition unit which receives a random value for each attribute from said random value identification device, and adds the random value of the attribute corresponding to the attribute value to the attribute value acquired by said attribute value acquisition unit; and
said random value identification device comprising:
a permission information storage unit which stores permission information indicating an attribute of which the user permits disclosure;
a reception unit which receives the attribute name from said information storing provider device;
an attribute correlation identification unit which identifies an attribute which is disclosed and has strong correlation with the first attribute as a second attribute based on permission information of the user who permits the discloser of the first attribute among permission information stored in said permission information storage;
an attribute value request unit which transmits the attribute name indicating the first attribute and the second attribute of the user associated with the permission information;
a correlation identification unit which identifies a correlation between the first attribute and the second attribute based on the attribute value received from said information storing provider device;
a range identification unit which identifies a range in which a random number can be taken between the first attribute and the second attribute based on the identified correlation;
a random number generation unit which generates the random number for each attribute in the range identified by said range identification unit; and
a random number transmission unit which transmits the generated random value to said information storing provider device.

12. A random value identification method comprising:
storing permission information indicating an attribute of which a user permits disclosure;
receiving a first attribute related to a user;
identifying an attribute which is disclosed and has strong correlation with the first attribute as a second attribute based on permission information of the user who permits the discloser of the first attribute among permission information stored in said permission information storage;
identifying a correlation between the first attribute and the second attribute based on the acquired attribute value of the first attribute and the second attribute; and
generating a range in which a random number can be taken between the first attribute and the second attribute which are identified based on the correlation.

13. A random value identification method comprising:
a search provider device
transmits an attribute name indicating a first attribute of information related to a user to a random value identification device; and
said random value identification device
stores the attribute name and an attribute value in an attribute value storage unit so that they are associated,
stores permission information indicating an attribute of which the user permits disclosure in a permission information storage unit,
receives the attribute name from said search provider device,
identifies an attribute which is disclosed and has strong correlation with the first attribute as a second attribute based on permission information of the user who permits the discloser of the first attribute among permission information stored in said permission information storage,
acquires the attribute value which is stored and associated with the first attribute and the second attribute of the user associated with the permission information for each the identified permission information from said attribute value storage unit,
identifies a correlation between the first attribute and the second attribute based on the acquired attribute value,
identified a range in which a random number can be taken between the first attribute and the second attribute which are identified based on the correlation,
generates a random number in the range,
adds the generated random value to the attribute value of the corresponding attribute, and
transmits the information to which the random value is added to said search provider device.

14. A random value identification method comprising:
a search provider device
transmits an attribute name indicating a first attribute of information related to a user to an information storing provider device;
said information storing provider device
stores the attribute name and an attribute value in an attribute value storage unit so that they are associated,
receives the attribute name from said search provider device, transmits the attribute name to said random value identification device,
acquires the attribute value associated with the attribute name which are received from said random value identification device from said attribute value storage unit,
transmits the attribute value to said random value identification device,
receives a random value from said random value identification device for each attribute, and adds the random value of the attribute corresponding to the attribute value to the acquired attribute value; and
said random value identification device
stores permission information indicating an attribute of which the user permits disclosure,
receives the attribute name from said information storing provider device,
identifies an attribute which is disclosed and has strong correlation with the first attribute as a second attribute based on permission information of the user who permits the discloser of the first attribute among permission information stored in said permission information storage,
transmits the attribute name indicating the first attribute and the second attribute of the user according to the permission information to said information storing provider device,
identifies a correlation between the first attribute and the second attribute based on the attribute value received from said information storing provider device,
identifies a range in which a random number can be taken between the first attribute and the second attribute based on the correlation which are identified,
generates a random number for each attribute in the range, and
transmits the generated random value to said information storing provider device.

15. A computer readable medium embodying a program, said program causing a random value identification device to perform a method, said method comprising:
storing permission information indicating an attribute of which a user permits disclosure;
receiving a first attribute of information related to a user;
identifying an attribute which is disclosed and has strong correlation with the first attribute as a second attribute based on permission information of the user who permits the discloser of the first attribute among permission information stored in said permission information storage;
identifying a correlation between the first attribute and the second attribute based on the acquired attribute value of the first attribute and the second attribute; and
generating a range in which a random number can be taken between the first attribute and the second attribute which are identified based on the correlation.

16. The random value identification device according to claim 1, wherein
said permission information storage unit stores the permission information and a user identifier of the user of the permission information,
said range identification unit identifies the range according to a number of each attribute, and
further comprising:
a random number generation unit which generates a random number for each attribute in the range identified by range identification unit.

17. A random value identification device comprising:
permission information storage means for storing permission information indicating at least one attribute of which a user permits disclosure and a user identifier of the user so that they are associated;
reception means for receiving an attribute name indicating a first attribute of information related to the user;
attribute correlation identification means for reading at least one permission information indicating the first attribute indicated by the attribute name from said permission information storage means, identifying a second attribute according to a cumulative total number indicated for each attribute among the attributes indicated by the read permission information, and identifying the permission information indicating the second attribute in the read permission information;
attribute value acquisition means for acquiring an attribute value corresponding to the first attribute and the second attribute of the user identified by the user identifier associated with the permission information for each the identified permission information;
correlation identification means for identifying a correlation between the first attribute and the second attribute based on the acquired attribute value; and
random number generation means for generating a random number for each attribute in a random value range which is a range in which the random number can be taken between the first attribute and the second attribute which are identified based on the correlation.
